(19) United States
(12) Patent Application Publication
(10) Pub. No.: US 2026/0281799 A1
(43) Pub. Date: Sep. 17, 2026

(54) QoS PROCESSING METHOD AND APPARATUS BASED ON NON-3GPP ACCESS, READABLE MEDIUM, AND DEVICE

(71) Applicant: Tencent Technology (Shenzhen) Company Limited, Shenzhen (CN)

(72) Inventors: Yixue LEI, Shenzhen (CN); Hao WANG, Shenzhen (CN)

(73) Assignee: Tencent Technology (Shenzhen) Company Limited, Shenzhen (CN)

(21) Appl. No.: 19/671,933

(22) Filed: May 8, 2026

Related U.S. Application Data
(63) Continuation of application No. PCT/CN2024/133616, filed on Nov. 21, 2024.

(30) Foreign Application Priority Data
Dec. 29, 2023 (CN) 202311872016.7

(51) Int. Cl. H04W 28/02; H04W 28/06

(52) U.S. Cl. CPC H04W 28/0268; H04W 28/0284; H04W 28/06

(57) ABSTRACT

Disclosed are a QoS processing method and apparatus based on non-3GPP access, a non-transitory computer-readable medium, and an electronic device. The method is performed by a target network element that is connected to a service processing device via a non-3GPP access manner and that is connected to a core network. The method includes: receiving, from a session management function (SMF) network element, QoS profile information corresponding to service data packet transmission performed between the service processing device and a service server; and performing, based on the QoS profile information, QoS processing during transmission of a service data packet between the service processing device and the service server. The disclosed solutions support a QoS mechanism in a non-3GPP access manner, thereby ensuring interworking and integration of the QoS mechanism between a 3GPP network and a non-3GPP network and improving processing flexibility of a service data flow while satisfying its QoS requirements.

### RELATED APPLICATION

This application is a continuation application of PCT Patent Application No. PCT/CN2024/133616, filed on Nov. 21, 2024, which claims priority to Chinese Patent Application No. 202311872016.7, filed with the China National Intellectual Property Administration on Dec. 29, 2023, each of which is incorporated herein by reference in its entirety.

### FIELD OF THE TECHNOLOGY

This application relates to the field of computer and communication technologies, and specifically, to a QoS processing method and apparatus based on non-3GPP access, a readable medium, and a device.

### BACKGROUND OF THE DISCLOSURE

In a 5th generation (5G) mobile communication technology and subsequent evolved systems (such as 5G-A and 6G) of the 5th generation mobile communication technology, a high-bandwidth interactive service is an important service type, such as cloud gaming, virtual reality (VR), augmented reality (AR), mixed reality (MR), extended reality (XR), cinematic reality (CR), XR and media services (XRM). These high-bandwidth interactive services have very high requirements on transmission timeliness. In addition, because a data amount is extremely large, data packets of these services impose higher requirements on control of quality of service (QoS) during transmission.

In addition, processing devices of the foregoing interactive services are not limited to a radio access technology (RAT) defined by the 3rd generation partnership project (3GPP) organization, and may also support a non-3GPP access manner, for example, wireless fidelity (Wi-Fi). In this case, how to ensure QoS requirements of these interactive services is a technical problem urgently to be resolved.

### SUMMARY

Embodiments of this disclosure provide a QoS processing method and apparatus based on non-3GPP access, a readable medium, and a device, to support a QoS mechanism in a non-3GPP access manner, thereby ensuring interworking and integration of the QoS mechanism between a 3GPP network and a non-3GPP network, and improving processing flexibility of a service data flow on a premise that a QoS requirement of the service data flow is ensured.

Other characteristics and advantages of this application will become clear through the following detailed descriptions or be partially learned through practice of this application.

According to a first aspect, an embodiment of this disclosure provides a QoS processing method based on non-3GPP access, the QoS processing method being performed by a target network element connected to a service processing device in a non-3GPP access manner, the target network element being connected to a core network, and the QoS processing method including: receiving QoS profile information that is transmitted by a session management function network element and that corresponds to service data packet transmission performed between the service processing device and a service server; and performing, according to the QoS profile information, QoS processing in a process of transmitting a service data packet between the service processing device and the service server.

According to a second aspect, an embodiment of this disclosure provides a QoS processing method based on non-3GPP access, the QoS processing method being performed by an application function network element, and the QoS processing method including: generating QoS requirement information for a service data packet, the service data packet being a data packet transmitted between a service server and a service processing device accessed in a non-3GPP access manner; and transmitting the QoS requirement information to a policy control function network element, so that the policy control function network element generates, according to the QoS requirement information, QoS policy information corresponding to the service data packet.

According to a third aspect, an embodiment of this disclosure provides a QoS processing method based on non-3GPP access, the QoS processing method being performed by a policy control function network element, and the QoS processing method including: obtaining QoS requirement information for a service data packet, the service data packet being a data packet transmitted between a service server and a service processing device accessed in a non-3GPP access manner; generating, according to the QoS requirement information, QoS policy information corresponding to the service data packet; and transmitting the QoS policy information to a session management function network element, so that the session management function network element configures, according to the QoS policy information, QoS processing-related information for a processing device of the service data packet.

According to a fourth aspect, an embodiment of this disclosure provides a QoS processing method based on non-3GPP access, the QoS processing method being performed by a session management function network element, and the QoS processing method including: receiving QoS policy information that is transmitted by a policy control function network element and that is configured for processing a service data packet, the service data packet being a data packet transmitted between a service server and a service processing device accessed in a non-3GPP access manner; generating, according to the QoS policy information, QoS processing-related information respectively corresponding to various types of processing devices of the service data packet; and configuring the QoS processing-related information for the processing devices of the service data packet.

In some embodiments of this application, based on the foregoing solutions, the generating, according to the QoS policy information, QoS processing-related information respectively corresponding to various types of processing devices of the service data packet includes:

generating, according to the QoS policy information and an access characteristic of the non-3GPP access manner, the QoS processing-related information respectively corresponding to the various types of processing devices of the service data packet; or

generating, according to the QoS policy information, the same QoS processing-related information for the non-3GPP access manner and a radio access network access manner.

According to a fifth aspect, an embodiment of this disclosure provides a QoS processing apparatus based on non-3GPP access, the QoS processing apparatus being applied to a target network element connected to a service processing device in a non-3GPP access manner, the target network element being connected to a core network, and the QoS processing apparatus including: a receiving unit, configured to receive QoS profile information that is transmitted by a session management function network element and that corresponds to service data packet transmission performed between the service processing device and a service server; and a processing unit, configured to perform, according to the QoS profile information, QoS processing in a process of transmitting a service data packet between the service processing device and the service server.

According to a sixth aspect, an embodiment of this disclosure provides a QoS processing apparatus based on non-3GPP access, the QoS processing apparatus being applied to an application function network element, and the QoS processing apparatus including: a generation unit, configured to generate QoS requirement information for a service data packet, the service data packet being a data packet transmitted between a service server and a service processing device accessed in a non-3GPP access manner; and a transmitting unit, configured to transmit the QoS requirement information to a policy control function network element, so that the policy control function network element generates, according to the QoS requirement information, QoS policy information corresponding to the service data packet.

According to a seventh aspect, an embodiment of this disclosure provides a QoS processing apparatus based on non-3GPP access, the QoS processing apparatus being applied to a policy control function network element, and the QoS processing apparatus including: an obtaining unit, configured to obtain QoS requirement information for a service data packet, the service data packet being a data packet transmitted between a service server and a service processing device accessed in a non-3GPP access manner; a generation unit, configured to generate, according to the QoS requirement information, QoS policy information corresponding to the service data packet; and a transmitting unit, configured to transmit the QoS policy information to a session management function network element, so that the session management function network element configures, according to the QoS policy information, QoS processing-related information for a processing device of the service data packet.

According to an eighth aspect, an embodiment of this disclosure provides a QoS processing apparatus based on non-3GPP access, the QoS processing apparatus being applied to a session management function network element, and the QoS processing apparatus including: a receiving unit, configured to receive QoS policy information that is transmitted by a policy control function network element and that is configured for processing a service data packet, the service data packet being a data packet transmitted between a service server and a service processing device accessed in a non-3GPP access manner; a generation unit, configured to generate, according to the QoS policy information, QoS processing-related information respectively corresponding to various types of processing devices of the service data packet; and a transmitting unit, configured to configure the QoS processing-related information for the processing devices of the service data packet.

According to a ninth aspect, an embodiment of this disclosure provides a computer-readable medium, having a computer program stored therein, and when the computer program is executed by a processor, the QoS processing method based on non-3GPP access according to the foregoing embodiments is implemented.

According to a tenth aspect, an embodiment of this disclosure provides an electronic device, including: one or more processors; and a storage apparatus (e.g., storage medium), configured to store one or more computer programs, and when the one or more computer programs are executed by the one or more processors, the electronic device is enabled to implement the QoS processing method based on non-3GPP access according to the foregoing embodiments.

According to an eleventh aspect, an embodiment of this disclosure provides a computer program product, the computer program product includes a computer program, and the computer program is stored in a computer-readable storage medium. A processor of an electronic device reads and executes the computer program from the computer-readable storage medium, so that the electronic device performs the QoS processing method based on non-3GPP access provided in the foregoing various exemplary embodiments.

In the technical solutions provided in some embodiments of this application, after a service processing device connects to a target network element in a non-3GPP access manner, the target network element receives QoS profile information that is transmitted by a core network element and that corresponds to service data packet transmission performed between the service processing device and a service server, and then performs, according to the QoS profile information, QoS processing in a process of transmitting a service data packet between the service processing device and the service server. In this way, a QoS mechanism may be supported in the non-3GPP access manner based on the target network element, and interworking and integration of the QoS mechanism between a 3GPP network and a non-3GPP network are ensured, so that the service processing device can further implement QoS processing on a service data flow through both a 3GPP RAT and the non-3GPP access manner (for example, a Wi-Fi access manner), and processing flexibility of the service data flow is improved on a premise that a QoS requirement of the service data flow is ensured, which is conducive to improving utilization of a network bandwidth and service processing quality.

The foregoing general descriptions and the following detailed descriptions are merely exemplary and explanatory, and cannot limit this application.

### BRIEF DESCRIPTION OF THE DRAWINGS

FIG. 1 is a schematic diagram of an exemplary system architecture that may be applied to technical solutions of embodiments of this application;

FIG. 2 is a schematic diagram of a transmission process of a multimedia data packet according to an embodiment of this disclosure;

FIG. 3 is a flowchart of a QoS processing method based on non-3GPP access according to an embodiment of this disclosure;

FIG. 4 is a flowchart of a QoS processing method based on non-3GPP access according to an embodiment of this disclosure;

FIG. 5 is a flowchart of a QoS processing method based on non-3GPP access according to an embodiment of this disclosure;

FIG. 6 is a flowchart of a QoS processing method based on non-3GPP access according to an embodiment of this disclosure;

FIG. 7 is a system architectural diagram of a trusted non-3GPP access manner according to an embodiment of this disclosure;

FIG. 8 is a system architectural diagram of an untrusted non-3GPP access manner according to an embodiment of this disclosure;

FIG. 9 is a block diagram of a QoS processing apparatus based on non-3GPP access according to an embodiment of this disclosure;

FIG. 10 is a block diagram of a QoS processing apparatus based on non-3GPP access according to an embodiment of this disclosure;

FIG. 11 is a block diagram of a QoS processing apparatus based on non-3GPP access according to an embodiment of this disclosure;

FIG. 12 is a block diagram of a QoS processing apparatus based on non-3GPP access according to an embodiment of this disclosure; and

FIG. 13 is a schematic structural diagram of a computer system of an electronic device that is suitable for implementing embodiments of this application.

### DESCRIPTION OF EMBODIMENTS

Now, exemplary implementations are described in a more comprehensive manner with reference to accompanying drawings. However, the exemplary implementations can be implemented in various forms, and are not to be understood as being limited to these examples. On the contrary, an objective of providing these implementations is to make this application more comprehensive and complete, and to comprehensively convey a concept of the exemplary implementations to a person in the art.

In addition, features, structures, or characteristics that are described in this application may be combined in one or more embodiments in any appropriate manner. There are many specific details in the following descriptions, so that embodiments of this application can be fully understood. However, a person skilled in the art is to be aware that, when technical solutions of this application are implemented, not all detailed features in the embodiments may be required to be used, one or more specific details may be omitted, or another method, element, apparatus, operation, or the like may be used.

In the embodiments of this application, a term "module" or "unit" refers to a computer program having a predetermined function or a part of a computer program, and the "module" or "unit" works with other relevant parts to achieve a predetermined goal, and the predetermined goal may be fully or partially achieved through software, hardware (such as a processing circuit or a memory), or a combination thereof. Similarly, one processor (or a plurality of processors or memories) may be configured to implement one or more modules or units. In addition, each module or each unit may both be a part of an integral module or an integral unit that includes a function of the module or the unit.

Block diagrams shown in the accompanying drawings are merely functional entities, and do not necessarily correspond to physically independent entities. In other words, these functional entities may be implemented in a form of software, or be implemented in one or more hardware modules or integrated circuits, or be implemented in different networks and/or processor apparatuses and/or microcontroller apparatuses.

Flowcharts shown in the accompanying drawings are merely exemplary descriptions, and do not necessarily include all content and operations/steps, and are not necessarily performed in a described sequence. For example, some operations/steps may further be decomposed, and some operations/steps may be combined or partially combined. Therefore, an actual sequence for performing these operations/steps may be changed according to an actual situation.

"A plurality of" mentioned in this specification means two or more. "And/or" describes an association relationship between associated objects, and represents that three relationships may exist. For example, A and/or B may represent that: Only A exists, both A and B exist, and only B exists. A character "/" generally represents an "or" relationship between the associated objects.

With the development of 5G and subsequent evolved systems (such as 5G-A and 6G) of 5G, many multimedia services that require a large data amount and a short delay are applied, for example, interactive services such as a cloud gaming service, VR, AR, MR, XR, and CR.

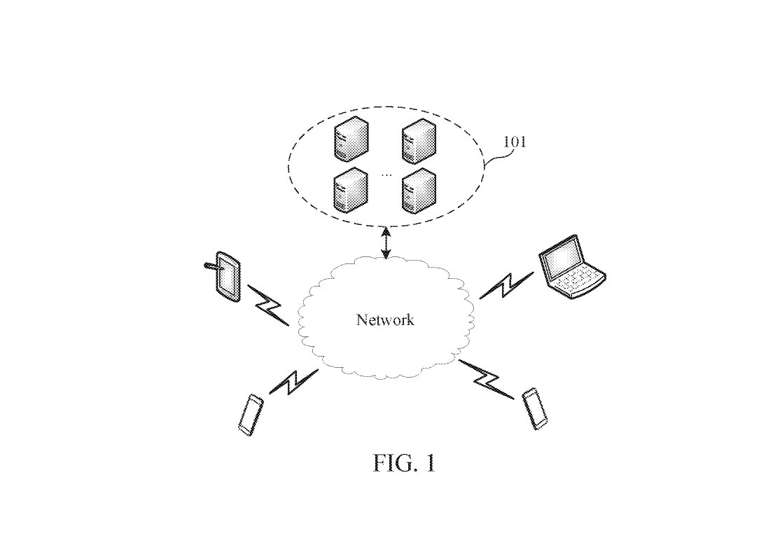

For example, in a cloud gaming scenario shown in FIG. 1, a cloud server 101 is configured to run a cloud game. The cloud server 101 may render a game picture, and encode an audio signal and the rendered picture, and finally transmit encoded data that is obtained through encoding to each game client through a network. The game client may be user equipment UE, such as a smartphone, a tablet computer, a notebook computer, a desktop computer, a smart television, a smart household, a vehicle-mounted terminal, or an aircraft, having a basic streaming media playback capability, a man-machine interaction capability, a communication capability, and the like; or the game client may be an application program running in a terminal device. Specifically, the game client may decode the encoded data transmitted by the cloud server 101, to obtain an analog audio/video signal, and play the analog audio/video signal.

FIG. 1 merely represents an exemplary system architecture of a cloud gaming system, and does not limit a specific architecture of the cloud gaming system. For example, in another embodiment, the cloud gaming system may further include a backend server for scheduling, and the like. In addition, the cloud server 101 may be an independent physical server, or may be a server cluster or a distributed system that is formed by a plurality of physical servers, or may also be a cloud server that provides a basic cloud computing service such as a cloud service, a cloud database, cloud computing, a cloud function, cloud storage, a network service, cloud communication, a middleware service, a domain name service, a security service, a content delivery network (CDN), big data, and an artificial intelligence platform. The game client and the cloud server 101 may be directly or indirectly connected in a wired or wireless communication manner. This is not limited in this application.

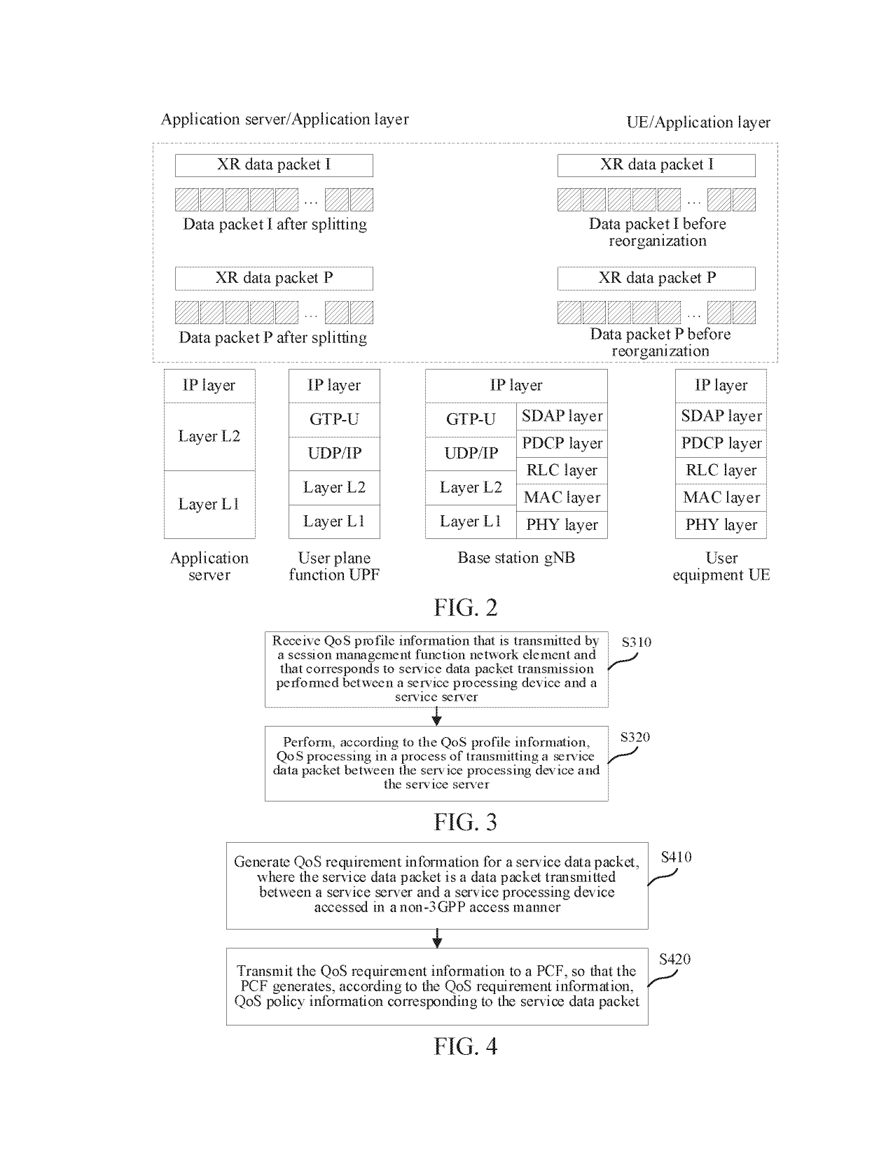

In the foregoing various multimedia-based interactive service application scenarios, because a multimedia data packet is huge, during transmission, the multimedia data packet needs to be split into a plurality of data packets for transmission. Specifically, as shown in FIG. 2, using a 5G system as an example, a user plane mainly includes an application server, a user plane function (UPF), a base station (next generation NodeB, gNB), and UE. For some typical service scenarios, a multimedia data packet is mainly transmitted in a downlink direction. For example, the multimedia data packet is transmitted from an application server (AS) to the UPF, and then is transmitted to the UE through the gNB. During transmission, the multimedia data packet (an XR data packet is used as an example in FIG. 2) is split at an application layer of the application server. After the split data packet is used as an internet protocol (IP) packet that arrives at the UPF from the application server, the 5G system transmits a data sub-packet to a UE end through a PDU session, and the data sub-packet is transmitted level by level from a protocol stack at the UE end, and the data sub-packet is reorganized to restore the multimedia data packet.

In the system shown in FIG. 2, a layer L1 refers to a physical layer, and is configured for ensuring that original data may be transmitted on various physical media. A layer L2 refers to a data link layer, and the data link layer provides a service for a network layer based on a service provided at the physical layer. An IP layer is the network layer, and is configured for implementing data transmission between two end systems. A UDP is a user datagram protocol, and the Chinese name is user datagram protocol. A GTP-U is a general packet radio service (GPRS) tunneling protocol, and the Chinese name is general packet radio service tunneling protocol user plane. PHY is short for physical, and the Chinese name is physical layer. MAC is media access control, and the Chinese name is media access control. RLC is radio link control, and the Chinese name is radio link control layer protocol. A PDCP is a packet data convergence protocol, and the Chinese name is packet data convergence protocol. An SDAP is a service data adaptation protocol, and the Chinese name is service data adaptation protocol.

As described above, for a multimedia service (such as an XRM service), splitting a frame of multimedia data into a plurality of data packets for transmission is very common. A data packet that is formed by a single multimedia service frame or a group of data packets (GoP) may also have a relatively large quantity of bytes, and the relatively large quantity of bytes need to be bore by a series of IP data packets. Specific correlation exists between these IP data packets, and processing these packets according to the correlation can effectively save a wireless network bandwidth.

For example, it is assumed that when data transmission is performed through a plurality of IP packets, the plurality of IP packets may form a PDU set. If some data packets in the PDU set are lost, an entire frame, the GoP, or other video content cannot be decoded, and remaining data in the PDU set is meaningless to a decoder end. However, if an application layer forward error correction (FEC) or another mechanism is introduced, a media application layer has a specific packet loss recovery capability or an anti-packet loss capability. In this way, after some packets are discarded, the remaining data in the PDU set can still be recovered for decoding, which indicates that the remaining data in the PDU set is still meaningful for decoding at a receive end.

In addition, in terms of a QoS processing mechanism, if different PDU sets are distinguished based on correlation between data packets at an application layer, a PDU set that has a high speed but can tolerate a specific proportion of packet loss rate or a latency excess rate may continue to be processed. In other words, a processing manner of the multimedia service may be more flexible. In addition, during processing of the multimedia service, both a RAT defined by a 3GPP organization and a non-3GPP access manner can be used. This is because in an actual scenario, using a device (such as a Wi-Fi device) that is not defined by a 3GPP organization to process the multimedia service is also very common. In this case, how to ensure a QoS requirement of the multimedia service during processing (especially, when the multimedia service is transmitted in a PDU set manner) is a technical problem urgently to be resolved.

Based on the foregoing problem, a technical solution in the embodiments of this application provides a new QoS processing solution based on non-3GPP access, to support a QoS mechanism in a non-3GPP access manner, thereby ensuring interworking and integration of the QoS mechanism between a 3GPP network and a non-3GPP network. In this way, a service processing device can further implement QoS processing on a service data flow through both a 3GPP RAT and the non-3GPP access manner (for example, a Wi-Fi access manner), which is conducive to improving utilization and service processing quality of a network bandwidth, to better tackle a challenge brought by a high-bandwidth interactive service to wireless network transmission.

The following describes implementation details of the technical solutions in the embodiments of this application in detail.

FIG. 3 is a flowchart of a QoS processing method based on non-3GPP access according to an embodiment of this disclosure. The QoS processing method may be performed by a target network element connected to a service processing device in a non-3GPP access manner, and the target network element is connected to a core network. For example, in a trusted non-3GPP access scenario, the QoS processing method shown in FIG. 3 may be performed by a trusted non-3GPP access network (TNAN) element, and the network element may be one or more of trusted non-3GPP access points (TNAPs) and trusted non-3GPP gateway functions (TNGFs), or may be another network element. For another example, in an untrusted non-3GPP access scenario, the QoS processing method shown in FIG. 3 may be performed by a non-3GPP interworking function (N3IWF) network element, or may be performed by another network element. As shown in FIG. 3, the QoS processing method based on non-3GPP access includes at least S310 and S320, and details are described as follows:

S310: Receive QoS profile information that is transmitted by a session management function network element and that corresponds to service data packet transmission performed between the service processing device and a service server.

In some exemplary embodiments, a service data packet transmitted between the service processing device and the service server may be transmitted in a data packet set (that is, a PDU set) manner. In this case, a QoS parameter included in the QoS profile information corresponding to the service data packet transmission performed between the service processing device and the service server may be at least one of the following parameters: a PDU set delay budget (PSDB), a PDU set error rate (PSER), a maximum data burst volume (MDBV), and a packet delay variation (PDV).

In some embodiments, the service data packet transmitted between the service processing device and the service server may not be transmitted in the PDU set manner, but is transmitted in a per-packet form. In this case, the QoS parameter included in the QoS profile information corresponding to the service data packet transmission performed between the service processing device and the service server may be at least one of the following parameters: a packet delay budget (PDB), a packet error rate (PER), a packet loss rate, the maximum data burst volume, and the like.

In some exemplary embodiments, a process in which the target network element obtains the QoS profile information corresponding to the service data packet may include: An AF generates QoS requirement information for the service data packet, and transmits the QoS requirement information to a PCF; the PCF generates, based on the QoS requirement information, QoS policy information for the service data packet, and transmits the QoS policy information to an SMF; and the SMF configures, according to the QoS policy information, QoS processing-related information for a processing device of the service data packet, where QoS processing-related information corresponding to the target network element is the foregoing QoS profile information.

In some exemplary embodiments, after generating the QoS profile information corresponding to the service data packet transmission performed between the service processing device and the service server, the SMF may transmit the QoS profile information to an access and mobility management function (AMF), and then the AMF transmits the QoS profile information to the target network element. In some embodiments, after generating the QoS profile information corresponding to the service data packet transmission performed between the service processing device and the service server, the SMF may transmit the QoS profile information to a UPF, and then the UPF transmits the QoS profile information to the target network element.

S320: Perform, according to the QoS profile information, QoS processing in a process of transmitting the service data packet between the service processing device and the service server.

In some exemplary embodiments, a process in which the target network element performs, according to the QoS profile information, QoS processing in the process of transmitting the service data packet between the service processing device and the service server may be performing QoS processing on an uplink data packet transmitted between the service processing device and the service server, or performing QoS processing on a downlink data packet transmitted between the service server and the service processing device.

In some exemplary embodiments, when the target network element performs, according to the QoS profile information, QoS processing in the process of transmitting the service data packet between the service processing device and the service server, a corresponding service data packet is discarded if the target network element detects, according to the QoS profile information, that at least one of the following conditions occurs in the process of transmitting the service data packet: congestion occurs in a process of transmitting a service data packet, transmission delay information of a service data packet is uncapable of satisfying a delay requirement, a bit error rate of a service data packet is uncapable of satisfying a bit error rate requirement, and a service data packet is determined as a useless and redundant data packet.

Specifically, if the target network element detects that transmission delay information of the downlink data packet from the service server is uncapable of satisfying the delay requirement included in the QoS profile information, the downlink data packet may be discarded. For the downlink data packet transmitted in the PDU set manner, the delay requirement included in the QoS profile information is the PSDB. For the downlink data packet transmitted in the per-packet manner, the delay requirement included in the QoS profile information is the PDB.

In some embodiments, if the target network element detects that a bit error rate of the downlink data packet from the service server is uncapable of satisfying the bit error rate requirement included in the QoS profile information, the downlink data packet may be discarded. For the downlink data packet transmitted in the PDU set manner, the bit error rate included in the QoS profile information is the PSER. For the downlink data packet transmitted in the per-packet manner, the bit error rate included in the QoS profile information is the PER.

In some embodiments, if the target network element detects that the downlink data packet from the service server experiences congestion during transmission, the downlink data packet may be discarded. For example, the downlink data packet may be discarded in ascending order of priorities of the downlink data packet.

In some embodiments, if the target network element detects that the useless and redundant data packet exists in the downlink data packet from the service server, for example, if the redundant data packet exists due to an FEC or another mechanism used for the downlink data packet, all valid data packets corresponding to the redundant data packet are normally transmitted, which indicates that the redundant data packet is an invalid data packet, that is, the redundant data packet does not need to be transmitted. Therefore, the redundant data packet may be discarded.

In some embodiments, if the target network element detects that transmission delay information of the uplink data packet from the service processing device is uncapable of satisfying the delay requirement included in the QoS profile information, the uplink data packet may be discarded. For the uplink data packet transmitted in the PDU set manner, the delay requirement included in the QoS profile information is the PSDB. For the uplink data packet transmitted in the per-packet manner, the delay requirement included in the QoS profile information is the PDB.

In some embodiments, if the target network element detects that a bit error rate of the uplink data packet from the service processing device is uncapable of satisfying the bit error rate requirement included in the QoS profile information, the uplink data packet may be discarded. For the uplink data packet transmitted in the PDU set manner, the bit error rate included in the QoS profile information is the PSER. For the uplink data packet transmitted in the per-packet manner, the bit error rate included in the QoS profile information is the PER.

In some embodiments, if the target network element detects that the uplink data packet from the service processing device experiences congestion during transmission, the uplink data packet may be discarded. For example, the uplink data packet may be discarded in ascending order of priorities of the uplink data packet.

In some embodiments, if the target network element detects that the useless and redundant data packet exists in the uplink data packet from the service processing device, for example, if the redundant data packet exists due to an FEC or another mechanism used for the uplink data packet, all valid data packets corresponding to the redundant data packet are normally transmitted, which indicates that the redundant data packet is an invalid data packet, that is, the redundant data packet does not need to be transmitted. Therefore, the redundant data packet may be discarded.

In some exemplary embodiments, the target network element may detect a process in which the service processing device transmits the service data packet in a non-3GPP access network environment, to determine whether congestion occurs in the process of transmitting the service data packet. For example, the target network element may detect a process of transmitting a downlink service data packet transmitted to the service processing device, to determine whether the downlink service data packet experiences congestion during transmission; or the target network element may detect a process of transmitting an uplink service data packet transmitted by the service processing device, to determine whether the uplink service data packet experiences congestion during transmission.

In some embodiments, if the service processing device accesses the target network element in an enhanced distributed channel access (EDCA) manner, whether congestion occurs may be determined according to a backoff frequency of the service processing device. For example, if the service processing device backs off frequently (for example, a quantity of backoff times per unit time reaches a set quantity of times), it indicates that congestion may occur.

EDCA provides different priorities and access classes, so that different data flows may obtain different transmission opportunities according to QoS requirements of the data flows. In addition, based on a competition and backoff mechanism, the EDCA implements fair competition and priority differentiation of service flows with different priorities on a channel by adjusting parameters such as backoff time and a size of a competition window. The EDCA defines the access classes, and each access class has different priorities and backoff parameter settings. These access classes may be configured according to service requirements, to satisfy different QoS requirements. For example, different access categories are set based on a voice, a video, data, and the like.

In some exemplary embodiments, the target network element may determine a priority of the service data packet according to field information included in the service data packet, to discard service data in ascending order of priorities when the service data needs to be discarded. In some embodiments, the field information may be, for example, PDU set important (PSI) information. In this case, importance of different PDU sets may be determined according to the field information, and the importance is positively correlated with the priority. In another embodiment of this disclosure, the priority of the service data packet may also be determined according to other field information. For example, a type of the service data packet is determined according to a field configured for representing the type of the service data packet, and then the priority of the service data packet is determined according to predetermined priorities of different types of data packets (for example, it is predetermined that a priority of a service data packet of a video type is higher than a priority of a service data packet of an audio type).

In some exemplary embodiments, after receiving the downlink data packet transmitted by the service server, the target network element further needs to transmit the downlink data packet to the service processing device, and the uplink data packet that needs to be transmitted to the service server by the service processing device also needs to be transmitted to the target network element first. Therefore, when QoS of the service data packet transmitted between the service processing device and the service server is processed, delay information between the target network element and the service processing device may be considered.

Specifically, when monitoring a transmission delay of the service data packet transmitted between the service processing device and the service server, the target network element may determine, with reference to the delay information between the target network element and the service processing device, whether the transmission delay of the service data packet satisfies a delay requirement included in QoS rule information. For example, a delay requirement of the downlink data packet transmitted by the service server to the service processing device is at most 50 ms. If the target network element finds, after receiving the downlink data packet, that there is already a delay of 40 ms, and a delay between the target network element and the service processing device is 15 ms, the target network element may determine that even if the downlink data packet is transmitted to the service processing device, the delay requirement still cannot be satisfied. Therefore, the downlink data packet may be discarded. However, if the target network element finds, after receiving the downlink data packet, that there is already a delay of 30 ms, and a delay between the target network element and the service processing device is 5 ms, the target network element may determine that the downlink data packet can satisfy the delay requirement.

In some exemplary embodiments, the target network element may obtain the delay information between the target network element and the service processing device, and then transmit the delay information to a specified core network element, so that a policy control function (PCF) generates, based on the delay information obtained from the specified core network element, policy information (that is, QoS policy information) configured for performing QoS processing on the service data packet transmitted between the service processing device and the service server. In other words, when generating the policy information for performing QoS processing, the PCF may consider the delay information between the target network element and the service processing device. In some embodiments, the specified core network element may be a network data analytics function (NWDAF) network element, or may be another network element such as the AMF network element or the application function (AF) network element.

In some exemplary embodiments, the delay information between the target network element and the service processing device may be an uplink transmission delay from the service processing device to the target network element.

In some exemplary embodiments, the target network element may monitor an uplink transmission process from the service processing device to the target network element within set duration, and then transmit an average value of detected transmission delays used as the uplink transmission delay to the specified core network element.

In some exemplary embodiments, the target network element may monitor the uplink transmission process from the service processing device to the target network element within the set duration, and then transmit a maximum value of the detected transmission delays used as the uplink transmission delay to the specified core network element.

In some exemplary embodiments, the target network element may monitor the uplink transmission process from the service processing device to the target network element within the set duration, and then transmit a minimum value of the detected transmission delays used as the uplink transmission delay to the specified core network element.

In some exemplary embodiments, the target network element may monitor the uplink transmission process from the service processing device to the target network element for a set quantity of times (for example, once, twice, or more times), and then transmit an average value of detected transmission delays used as the uplink transmission delay to the specified core network element.

In some exemplary embodiments, the target network element may monitor the uplink transmission process from the service processing device to the target network element for the set quantity of times (for example, once, twice, or more times), and then transmit a maximum value of the detected transmission delays used as the uplink transmission delay to the specified core network element.

In some exemplary embodiments, the target network element may monitor the uplink transmission process from the service processing device to the target network element for the set quantity of times (for example, once, twice, or more times), and then transmit a minimum value of the detected transmission delays used as the uplink transmission delay to the specified core network element.

A manner of calculating the uplink transmission delay from the service processing device to the target network element is not limited in this embodiment of this disclosure.

In some exemplary embodiments, the delay information between the target network element and the service processing device may be a downlink transmission delay from the target network element to the service processing device.

In some exemplary embodiments, the target network element may monitor a downlink transmission process from the target network element to the service processing device within set duration, and then transmit an average value of detected transmission delays used as the downlink transmission delay to the specified core network element.

In some exemplary embodiments, the target network element may monitor the downlink transmission process from the target network element to the service processing device within the set duration, and then transmit a maximum value of the detected transmission delays used as the downlink transmission delay to the specified core network element.

In some exemplary embodiments, the target network element may monitor the downlink transmission process from the target network element to the service processing device within the set duration, and then transmit a minimum value of the detected transmission delays used as the downlink transmission delay to the specified core network element.

In some exemplary embodiments, the target network element may monitor the downlink transmission process from the target network element to the service processing device for a set quantity of times (for example, once, twice, or more times), and then transmit an average value of detected transmission delays used as the downlink transmission delay to the specified core network element.

In some exemplary embodiments, the target network element may monitor the downlink transmission process from the target network element to the service processing device for the set quantity of times (for example, once, twice, or more times), and then transmit a maximum value of the detected transmission delays used as the downlink transmission delay to the specified core network element.

In some exemplary embodiments, the target network element may monitor the downlink transmission process from the target network element to the service processing device for the set quantity of times (for example, once, twice, or more times), and then transmit a minimum value of the detected transmission delays used as the downlink transmission delay to the specified core network element.

A manner of calculating the downlink transmission delay from the service processing device to the target network element is not limited in this embodiment of this disclosure.

In some exemplary embodiments, the delay information between the target network element and the service processing device may be calculated based on the downlink transmission delay from the target network element to the service processing device and the uplink transmission delay from the service processing device to the target network element.

In some exemplary embodiments, the target network element may use an average value of the uplink transmission delay and the downlink transmission delay as the delay information between the service processing device and the target network element.

In some exemplary embodiments, the target network element may use a maximum value of the uplink transmission delay and the downlink transmission delay as the delay information between the service processing device and the target network element.

In some exemplary embodiments, the target network element may use a minimum value of the uplink transmission delay and the downlink transmission delay as the delay information between the service processing device and the target network element.

A manner of calculating the delay information between the service processing device and the target network element is not limited in this embodiment of this disclosure.

The uplink transmission delay and the downlink transmission delay in this embodiment may also be obtained in the manners in the foregoing embodiments. In other words, the uplink transmission delay and the downlink transmission delay are obtained in a manner of monitoring the uplink transmission process and the downlink transmission process for the set duration or the set quantity of times to calculate the average value, the maximum value, and the minimum value, or may be obtained in a single-time measurement manner. This is not limited in this embodiment of this disclosure.

In some exemplary embodiments, when detecting that the service data packet transmitted between the service processing device and the service server experiences congestion, the target network element may further perform explicit congestion notification (ECN) marking on the service data packet (the service data packet may be the uplink service data packet or the downlink service data packet).

In some embodiments, when ECN marking is performed on the uplink service data packet, ECN marking may be set in an IP header of the uplink service data packet, to indicate that the uplink service data packet experiences network congestion. After the uplink service data packet is transmitted to the service server, the service server learns, according to ECN marking in the uplink service data packet, that the uplink service data packet experiences congestion during transmission, and then the service server replies an ACK message with an ECN-echo to the service processing device. When receiving the ACK message with the ECN-echo, the service processing device knows that the uplink service data packet experiences congestion in a network path, and correspondingly adjusts a transmitting rate of the uplink service data packet, to avoid further congestion.

In some embodiments, when ECN marking is performed on the downlink service data packet, ECN marking may be set in an IP header of the downlink service data packet, to indicate that the downlink service data packet experiences network congestion. After the downlink service data packet is transmitted to the service processing device, the service processing device learns, according to ECN marking in the downlink service data packet, that the downlink service data packet experiences congestion during transmission, and then the service processing device replies the ACK message with the ECN-echo to the service server. When receiving the ACK message with the ECN-echo, the service server knows that the downlink service data packet experiences congestion in the network path, and correspondingly adjusts a transmitting rate of the downlink service data packet, to avoid further congestion.

In some exemplary embodiments, the target network element may perform, through a low latency, low loss, and scalable throughput (L4S) technology, relay processing on the service data packet transmitted between the service processing device and the service server.

The low latency refers to duration required for data transmission from a transmit end to a receive end is as short as possible. The latency refers to a time delay during transmission, and may affect a response speed and performance of an application program. A low latency technology can reduce a transmission time, and improve a response speed and user experience of the application program. The low loss refers to a case in which a loss rate of a data packet is as low as possible in a network transmission process. A packet loss refers to a case in which some data packets are not successfully transmitted to the receive end in the network transmission process. A low loss technology can ensure integrity and reliability of data, and avoid errors and losses in the data transmission process. The scalable throughput means that a data processing capability of a network or a system may be expanded according to a requirement. A scalable throughput technology may adjust a processing capability of the network or the system according to an actual requirement, to ensure efficient operation and scalability of the system.

In the technical solution in this embodiment of this disclosure, the target network element may implement congestion marking processing based on the L4S technology, which further helps to reduce latency, reduce a packet loss rate, and implement the scalable throughput. In addition, because congestion marking processing based on the L4S technology provides early congestion feedback, the transmit end can adjust the transmitting rate in a timely manner, thereby improving performance and stability of the network. In addition, in this embodiment of this disclosure, interworking and integration of the L4S technology between the 3GPP network and the non-3GPP network can be implemented, to further ensure that the service processing device can implement L4S based congestion processing through both the 3GPP RAT and the non-3GPP access manner, which is conducive to improving utilization and service processing quality of a network bandwidth.

In some exemplary embodiments, a process in which the target network element performs, according to the QoS profile information, QoS processing in the process of transmitting the service data packet between the service processing device and the service server may include: mapping a QoS parameter included in the QoS profile information to a QoS mechanism of the non-3GPP access manner, and mapping, according to the QoS mechanism of the non-3GPP access manner, the downlink service data packet transmitted by the service server to a bearer corresponding to the non-3GPP access manner, to transmit the downlink service data packet to the service processing device.

In some exemplary embodiments, the mapping a QoS parameter included in the QoS profile information to a QoS mechanism of the non-3GPP access manner may be understood as applying the QoS parameter included in the QoS profile information to the QoS mechanism of the non-3GPP access manner.

In some exemplary embodiments, the QoS profile information includes: a data flow QoS parameter.

The data flow QoS parameter may be a 5G QoS parameter, that is, a QoS parameter of a 5G QoS flow. Certainly, the data flow QoS parameter may also be a QoS parameter of a data flow in another form. The data flow in another form may be a data flow with a finer granularity relative to the 5G QoS flow, but is not limited thereto.

In some exemplary embodiments, the 5G QoS parameter includes: a 5G quality of service identifier (5QI), an allocation and retention priority (ARP), a guaranteed flow bit rate (GSBR), and a maximum flow bit rate (MFBR).

In some exemplary embodiments, the 5G QoS parameter further includes at least one of the following: a reflective QoS attribute (RQA) and a maximum packet loss rate.

In some exemplary embodiments, the QoS parameter of the data flow in another form may be similar to the 5G QoS parameter.

In some exemplary embodiments, that the target network element maps, according to the QoS mechanism of the non-3GPP access manner, the downlink service data packet transmitted by the service server to the bearer corresponding to the non-3GPP access manner, to transmit the downlink service data packet to the service processing device includes: determining, by the target network element, a data flow to which the downlink service data packet belongs; and mapping, according to the data flow QoS parameter, the data flow to which the downlink service data packet belongs to the bearer corresponding to the non-3GPP access manner, to transmit the downlink service data packet to the service processing device.

For example, if the service processing device is connected to the target network element in a Wi-Fi access manner, the target network element may determine the data flow to which the downlink service data packet belongs, and map, according to the data flow QoS parameter such as a priority, the data flow to which the downlink service data packet belongs to a transmission opportunity (TXOP) corresponding to the Wi-Fi access manner, or to some transmitting resources of a TXOP corresponding to the Wi-Fi access manner.

The TXOP may be considered as a channel access mechanism, and is configured for managing access and data transmission of a wireless channel. The TXOP divides, based on an idea of time-division multiplexing (TDM), a channel into different time intervals, and each time interval is allocated to one station (SAT) device for data transmission. A TXOP of each station is controlled to implement fair allocation and effective utilization of channel resources, thereby improving performance and efficiency of the network. Therefore, the data flow may be mapped to the TXOP corresponding to the Wi-Fi access manner, or the TXOP is further divided, and the data flow is mapped to some transmission resources (for example, a period of transmitting time) of the TXOP corresponding to the Wi-Fi access manner.

In some exemplary embodiments, the QoS profile information further includes a PDU set QoS parameter. As described above, the PDU set QoS parameter includes at least one of the PSDB, the PSER, the MDBV, and the PDV.

In some exemplary embodiments, that the target network element maps, according to the QoS mechanism of the non-3GPP access manner, the downlink service data packet transmitted by the service server to the bearer corresponding to the non-3GPP access manner, to transmit the downlink service data packet to the service processing device includes: determining, by the target network element, the data flow and a PDU set to which the downlink service data packet belongs; and mapping, according to the data flow QoS parameter and the PDU set QoS parameter, the data flow and the PDU set to which the downlink service data packet belongs to the bearer corresponding to the non-3GPP access manner, to transmit the downlink service data packet to the service processing device.

In some possible implementations, one data flow may include one or more PDU sets.

For example, if the service processing device is connected to the target network element in the Wi-Fi access manner, the target network element may determine the data flow and the PDU set to which the downlink service data packet belongs, and map, according to the data flow QoS parameter and the PDU set QoS parameter, the data flow and the PDU set to which the downlink service data packet belongs to the TXOP corresponding to the Wi-Fi access manner, or to some transmission resources of the TXOP corresponding to the Wi-Fi access manner.

The foregoing describes the technical solution in this embodiment of this disclosure from a perspective of the target network element connected to the service processing device in the non-3GPP access manner. The following further describes implementation details of the technical solution in this embodiment of this disclosure from the perspective of another network element.

FIG. 4 is a flowchart of a QoS processing method based on non-3GPP access according to an embodiment of this disclosure. The QoS processing method may be performed by an AF, or may be performed by another network element. As shown in FIG. 4, the QoS processing method based on non-3GPP access includes at least S410 and S420, and details are described as follows:

S410: Generate QoS requirement information for a service data packet, where the service data packet is a data packet transmitted between a service server and a service processing device accessed in a non-3GPP access manner.

In some exemplary embodiments, the service data packet transmitted between the service processing device and the service server may be transmitted in a PDU set manner. In this case, a QoS parameter included in the QoS requirement information for the service data packet may be at least one of the following parameters: a PSDB, a PSER, an MDBV, and a PDV.

In some embodiments, when the service data packet is transmitted between the service processing device and the service server, the service data packet may not be transmitted in the PDU set manner, but is transmitted in a per-packet form. In this case, the QoS parameter included in the QoS requirement information for the service data packet may be at least one of the following parameters: a PDB, a PER, a maximum data burst volume, and the like.

In some exemplary embodiments, the AF may generate the QoS requirement information according to an access characteristic of the non-3GPP access manner, so that the generated QoS requirement information can be more matched with the access characteristic of the non-3GPP access manner.

In some embodiments, the access characteristic of the non-3GPP access manner may include statistical indicators such as a bandwidth condition, a delay condition, a jitter characteristic, reliability, and a packet loss rate, and may also include one or more pieces of other information such as a supported QoS capability. For example, an example in which the non-3GPP access manner is a Wi-Fi access manner is used. An access characteristic of the Wi-Fi access manner may also include other media access control (MAC) layer parameters such as QoS capabilities for different access classes (AC) and a backoff mechanism.

In some exemplary embodiments, the AF may also generate the same QoS requirement information for the non-3GPP access manner and a radio access network (RAN) access manner. In other words, in this embodiment, a set of unified QoS requirement information may be generated without distinguishing access manners of the service processing device. In this way, a processing procedure of a system may be simplified.

S420: Transmit the QoS requirement information to a PCF, so that the PCF generates, according to the QoS requirement information, QoS policy information corresponding to the service data packet.

In some exemplary embodiments, when transmitting the QoS requirement information to a core network element, the AF may directly transmit the QoS requirement information to the PCF. Alternatively, the QoS requirement information may also be transmitted to a network exposure function (NEF), and then the NEF forwards the QoS requirement information to the PCF. Alternatively, the AF may negotiate a service level agreement (SLA) with the PCF, to transfer the QoS requirement information to the PCF.

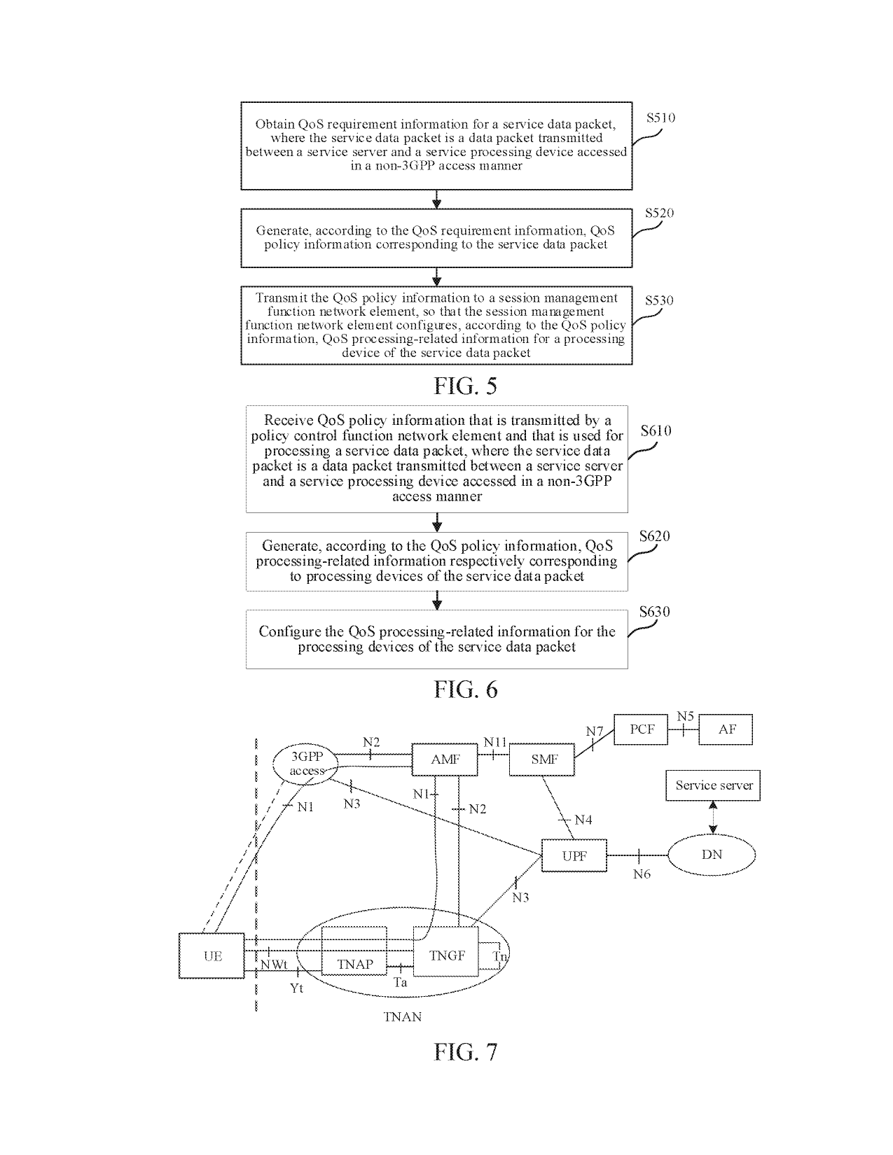

FIG. 5 is a flowchart of a QoS processing method based on non-3GPP access according to an embodiment of this disclosure. The QoS processing method may be performed by a PCF, or may be performed by another network element. As shown in FIG. 5, the QoS processing method based on non-3GPP access includes at least S510 to S530, and details are described as follows:

S510: Obtain QoS requirement information for a service data packet, where the service data packet is a data packet transmitted between a service server and a service processing device accessed in a non-3GPP access manner.

In some exemplary embodiments, a PCF may directly receive the QoS requirement information that is transmitted by an AF and that is for the service data packet, or may receive the QoS requirement information that is forwarded by an NEF and that is from an AF, or the PCF may obtain the QoS requirement information by negotiating an SLA with an AF.

In some exemplary embodiments, the service data packet transmitted between the service processing device and the service server may be transmitted in a PDU set manner. In this case, a QoS parameter included in the QoS requirement information for the service data packet may be at least one of the following parameters: a PSDB, a PSER, an MDBV, and a PDV.

In some embodiments, when the service data packet is transmitted between the service processing device and the service server, the service data packet may not be transmitted in the PDU set manner, but is transmitted in a per-packet form. In this case, the QoS parameter included in the QoS requirement information for the service data packet may be at least one of the following parameters: a PDB, a PER, a maximum data burst volume, and the like.

S520: Generate, according to the QoS requirement information, QoS policy information corresponding to the service data packet.

In some exemplary embodiments, the PCF may generate, according to the QoS requirement information and an access characteristic of the non-3GPP access manner, the QoS policy information corresponding to the service data packet, so that the generated QoS policy information can be more matched with the access characteristic of the non-3GPP access manner.

In some embodiments, the access characteristic of the non-3GPP access manner may include statistical indicators such as a bandwidth condition, a delay condition, a jitter characteristic, reliability, and a packet loss rate, and may also include one or more pieces of other information such as a supported QoS capability. For example, an example in which the non-3GPP access manner is a Wi-Fi access manner is used. An access characteristic of the Wi-Fi access manner may further include other MAC layer parameters such as QoS capabilities for different ACs and a backoff mechanism.

In some exemplary embodiments, the PCF may also generate, according to the QoS requirement information, the same QoS policy information for the non-3GPP access manner and a RAN access manner. In other words, in this embodiment, a set of unified QoS policy information may be generated without distinguishing access manners of the service processing device. In this way, a processing procedure of a system may be simplified.

S530: Transmit the QoS policy information to a session management function network element, so that the session management function network element configures, according to the QoS policy information, QoS processing-related information for a processing device of the service data packet.

In some exemplary embodiments, a process in which the PCF transmits the QoS policy information to an SMF may be that the PCF interacts with the SMF through a session management policy association establishment signaling procedure, or the PCF interacts with the SMF through a session management policy association modification signaling process, and then the PCF transmits related policy information to the SMF through a session management policy context data information element.

In some embodiments, for a process in which the SMF configures, according to the QoS policy information, the QoS processing-related information for the processing device of the service data packet, refer to the following embodiment shown in FIG. 6.

FIG. 6 is a flowchart of a QoS processing method based on non-3GPP access according to an embodiment of this disclosure. The QoS processing method may be performed by an SMF, or may be performed by another network element. As shown in FIG. 6, the QoS processing method based on non-3GPP access includes at least S610 to S630, and details are described as follows:

S610: Receive QoS policy information that is transmitted by a policy control function network element and that is configured for processing a service data packet, where the service data packet is a data packet transmitted between a service server and a service processing device accessed in a non-3GPP access manner.

In some embodiments, for a generation process of the QoS policy information transmitted by a PCF and related descriptions, refer to the technical solutions in the foregoing embodiments, and details are not described again.

S620: Generate, according to the QoS policy information, QoS processing-related information respectively corresponding to processing devices of the service data packet.

In some exemplary embodiments, that the SMF may generate, according to the QoS policy information and an access characteristic of the non-3GPP access manner, the QoS processing-related information respectively corresponding to the various types of processing devices of the service data packet, so that the generated QoS processing-related information can be more matched with the access characteristic of the non-3GPP access manner.

In some embodiments, the access characteristic of the non-3GPP access manner may include statistical indicators such as a bandwidth condition, a delay condition, a jitter characteristic, reliability, and a packet loss rate, and may also include one or more pieces of other information such as a supported QoS capability. For example, an example in which the non-3GPP access manner is a Wi-Fi access manner is used. An access characteristic of the Wi-Fi access manner may further include other MAC layer parameters such as QoS capabilities for different ACs and a backoff mechanism.

In some exemplary embodiments, the SMF may also generate, according to the QoS policy information, the same QoS processing-related information for the non-3GPP access manner and a RAN access manner. In other words, in this embodiment, a set of unified QoS processing-related information may be generated without distinguishing access manners of the service processing device. In this way, a processing procedure of a system may be simplified.

In some exemplary embodiments, the various types of processing devices of the service data packet may include a UPF, a target network element, and the service processing device. Specifically, QoS processing-related information generated by the SMF for the UPF may be a service data flow (SDF) template; QoS processing-related information generated by the SMF for the target network element may be QoS profile information (QoS profiles); and QoS processing-related information generated by the SMF for the service processing device may be QoS rule information (QoS rules).

S630: Configure the QoS processing-related information for the processing devices of the service data packet.

In some exemplary embodiments, a process of configuring the QoS processing-related information for the processing devices of the service data packet may include: transmitting the SDF template to the UPF, transmitting the QoS profile information to the target network element, and transmitting the QoS rule information to the service processing device.

In some embodiments, when transmitting the QoS profile information to the target network element, the SMF may transmit the QoS profile information to an AMF, and then the AMF transmits the QoS profile information to the target network element. In some embodiments, the SMF may also transmit the QoS profile information to the UPF, and then the UPF transmits the QoS profile information to the target network element.

In some embodiments, when transmitting the QoS rule information to the service processing device, the SMF may transmit the QoS rule information to the AMF, then the AMF transmits the QoS rule information to the target network element, and then the target network element transmits the QoS rule information to the service processing device. In some embodiments, if the service processing device can also support accessing a core network in a 3GPP access manner, the SMF may also transmit the QoS rule information to the AMF, and then the AMF transmits the QoS rule information to the service processing device through a RAN.

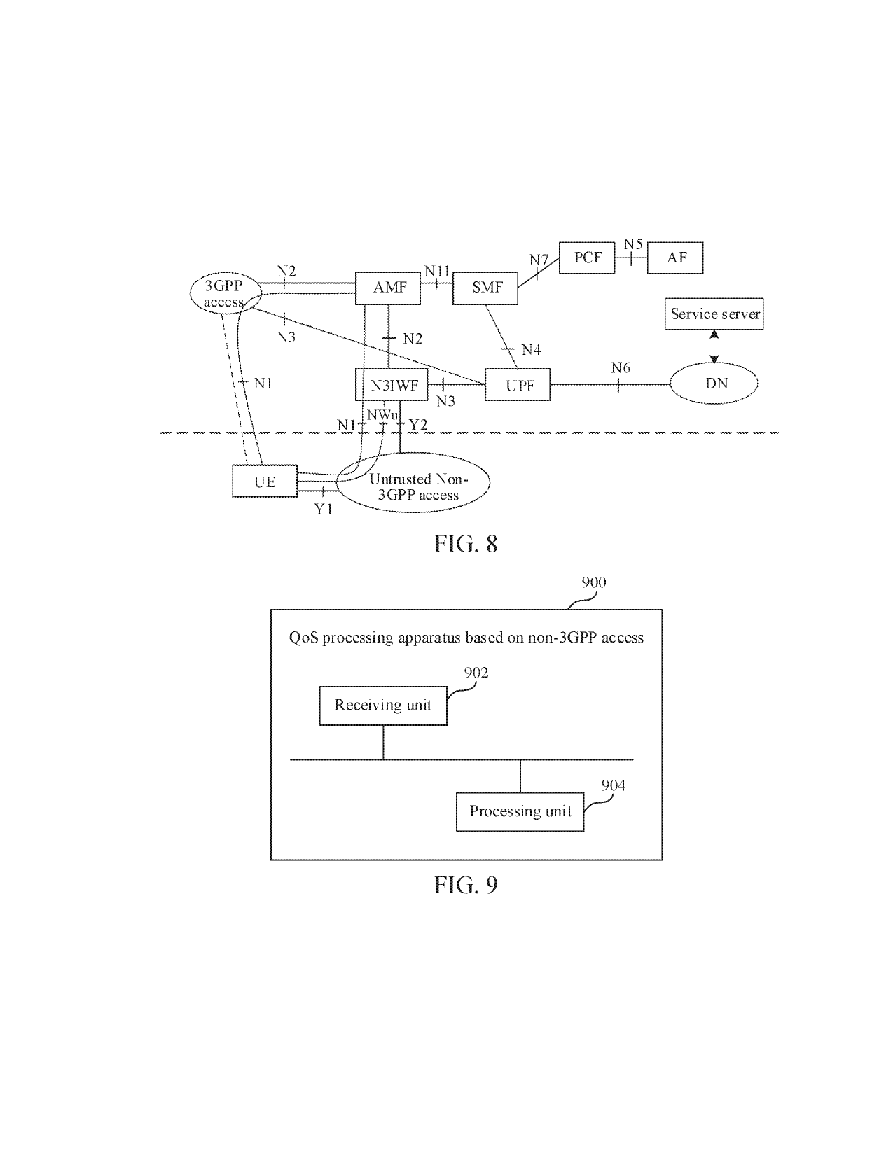

With reference to FIG. 7 and FIG. 8, the following describes the implementation details of the technical solution in this embodiment of this disclosure in detail by using an example in which a non-3GPP access manner is a Wi-Fi access manner.

As shown in FIG. 7, in a system architecture of a trusted non-3GPP access manner, a TNAN is connected to core network elements: an AMF and a UPF. A service processing device (that is, UE shown in FIG. 7) may access a 5G core network through the TNAN, or if the UE has a capability of a 3GPP RAT, the UE may also access a 5G core network through 3GPP access. The TNAN includes a TNAP and a TNGF, and a service server is located at a backend of the 5G core network, and is connected to a data network (DN).

In an embodiment of this disclosure, to enable the system architecture shown in FIG. 7 to support a PDU set characteristic of trusted 3GPP access, the TNGF and the TNAP may provide, based on a Wi-Fi network (the Wi-Fi network is used as an example for description), transmission of NAS signaling and transmission of user plane data.

In some exemplary embodiments, for different characteristics of Wi-Fi, new functions need to be introduced to a function of an AF and a function of a PCF, but are not limited to the following: a function of performing optimization with reference to an access characteristic of the trusted Wi-Fi access when the AF generates a QoS requirement, and the PCF generates PCC rules; and a function of performing setting with reference to a Wi-Fi characteristic, when QoS monitoring or ECN marking for L4S is started.

In some embodiments, the access characteristic of the trusted Wi-Fi access may include statistical indicators such as a bandwidth condition, a delay condition, a jitter characteristic, reliability, and a packet loss rate, and may further include other MAC layer parameters such as a supported QoS capability, QoS capabilities for different ACs, and a backoff mechanism. When the AF generates the QoS requirement, the PCF generates a PCC rule, and QoS monitoring or ECN marking for L4S is started, optimization is performed with reference to the access characteristic of the trusted Wi-Fi access, so that QoS processing that is performed can be more matched with the access characteristic of the trusted Wi-Fi access, thereby ensuring an effect and quality of QoS processing.

In some exemplary embodiments, if the UE is the trusted Wi-Fi access, when the AF proposes QoS requirement information, and the PCF generates the PCC rule according to the QoS requirement information, the PCC rule that is more easily mapped to QoS of Wi-Fi may be generated with reference to a characteristic of the trusted Wi-Fi access. For example, because support for per flow QoS that is provided by Wi-Fi is relatively little, when the AF provides the QoS requirement information, and the PCF generates the PCC rule, per-class QoS that is similar to a differentiated service code point (DSCP) may be considered, that is, class-based QoS is used. For example, access classes (ACs) corresponding to different service data are classified, and corresponding QoS requirement information and corresponding PCC rules are set for different access classes. When a 5G QoS identifier (5QI) is selected, a characteristic (including but not limited to indicators such as a bandwidth, a delay, a jitter characteristic, reliability, and a packet loss rate that are obtained through a QoS monitoring mechanism) of a current trusted Wi-Fi access network may also be taken into account, so that QoS is more easily mapped between 5G and Wi-Fi.

In some exemplary embodiments, to simplify a protocol, the 5GC may also generate a unified set of QoS parameters configured for both NG-RAN access and the trusted Wi-Fi access, to block different characteristics of different trusted Wi-Fi accesses.

In some exemplary embodiments, new functions may be introduced to an SMF, but are not limited to the following: a function of performing optimization on the SMF with reference to the access characteristic of the trusted Wi-Fi access when the SMF configures a QoS profile, a QoS rule, and an N4 rule (the N4 rule is QoS processing-related information transmitted to the UPF), so that QoS is more easily mapped between 5G and the Wi-Fi.

In some exemplary embodiments, new functions are introduced to the TNAN (specifically, the TNAN may be either of the TNGF and the TNAP, or a combination of thereof), but are not limited to the following:

1. A function of supporting a radio access side function in PDU set QoS processing, including but not limited to discarding a data packet in a PDU set when congestion occurs or useless and redundant data is detected.

In some embodiments, the function may be configured for performing congestion detection in a trusted Wi-Fi network environment. For example, congestion is detected by collecting a backoff frequency of the UE. In an EDCA manner, both a backoff frequency of UE that accesses Wi-Fi and a backoff frequency of an access point (that is, the TNAP) of Wi-Fi can be used to determine a congestion condition of a network.

In some embodiments, the function may be configured for identifying PSI or another field at an N2/N3 termination point such as the TNGF, to select an appropriate data packet to perform a discarding operation when congestion occurs.

In some embodiments, specific parameters, such as a delay time requirement and a packet loss rate requirement, of operations, such as PDU set QoS processing and data packet discarding that are performed in a trusted Wi-Fi access condition may be determined according to parameters such as a PSDB and a PSER that are provided by the 5GC.

2. A function of mapping downlink PDU set data to a Wi-Fi bearer, and mapping a 5G QoS parameter + PDU set QoS to a QoS mechanism of Wi-Fi.

In some embodiments, through the mechanism, a 5G QoS flow or a data flow with a finer granularity may be mapped to a TXOP of trusted Wi-Fi.

In some embodiments, the TNAN may map PDU set data to a transmitting resource of the TXOP according to a resource characteristic of the TXOP.

3. In terms of delay monitoring, a function of considering a delay between the UE and the TNAN, to correct a QoS delay requirement of a 5GS.

In some embodiments, if the 5GS starts QoS monitoring, delay measurement and reporting are performed between the UE and the TNAN (for example, the TNGF), and the TNAN (for example, the TNGF) takes on a role of the N2/N3 termination point of the NG-RAN.

4. A function of performing congestion-based ECN marking for L4S.

In some embodiments, after the TNAN (for example, the TNGF) detects congestion in the trusted Wi-Fi access environment, the TNAN (for example, the TNGF) may perform an operation of ECN marking for L4S.

In some exemplary embodiments, functions may be introduced to the UE, but are not limited to the following: a function of performing QoS optimization processing with reference to the access characteristic of the trusted Wi-Fi access after the QoS rule configured by the SMF is obtained; and a function of completing QoS monitoring processing in coordination with the TNAN (for example, the TNGF or the TNAP), for example, completing measurement of a delay.

As shown in FIG. 8, in a system architecture of an untrusted non-3GPP access manner, an N3IWF is connected to core network elements: an AMF and a UPF. A service processing device (that is, UE shown in FIG. 8) may access the N3IWF in an untrusted non-3GPP access manner (for example, an internet protocol security (IPSec) tunnel is established between the UE and the N3IWF, so that a 5G core network is connected in the untrusted non-3GPP access manner), and access the 5G core network through the N3IWF, or if the UE has a capability of a 3GPP RAT, the UE may also access a 5G core network through 3GPP access. A service server is located at a backend of the 5G core network, and is connected to a DN.

In an embodiment of this disclosure, to enable the system architecture shown in FIG. 8 to support a PDU set characteristic of trusted 3GPP access, the N3IWF may provide, based on a Wi-Fi network (the Wi-Fi network is used as an example for description), transmission of NAS signaling and transmission of user plane data.

In some exemplary embodiments, for different characteristics of Wi-Fi, new functions need to be introduced to a function of an AF and a function of a PCF, but are not limited to the following: a function of performing optimization with reference to an access characteristic of untrusted Wi-Fi access when the AF generates a QoS requirement, and the PCF generates a PCC rule; and a function of performing setting with reference to a Wi-Fi characteristic when QoS monitoring or ECN marking for L4S is started.

In some embodiments, the access characteristic of the untrusted Wi-Fi access may include statistical indicators such as a bandwidth condition, a delay condition, a jitter characteristic, reliability, and a packet loss rate, and may further include other MAC layer parameters such as a supported QoS capability, QoS capabilities for different ACs, and a backoff mechanism. When the AF generates the QoS requirement, the PCF generates a PCC rule, and QoS monitoring or ECN marking for L4S is started, optimization is performed with reference to the access characteristic of the untrusted Wi-Fi access, so that QoS processing that is performed can be more matched with the access characteristic of the untrusted Wi-Fi access, thereby ensuring an effect and quality of QoS processing.

In some exemplary embodiments, if the UE is the untrusted Wi-Fi access, when the AF proposes QoS requirement information, and the PCF generates the PCC rule according to the QoS requirement information, the PCC rule that is more easily mapped to QoS of Wi-Fi is generated with reference to the characteristic of the untrusted Wi-Fi access. For example, because support for per flow QoS provided by the Wi-Fi is relatively little, when the AF provides the QoS requirement information, and the PCF generates the PCC rule, per-class QoS that is similar to a DSCP may be considered, that is, class-based QoS is used, for example, access classes (ACs) corresponding to different service data are classified, and corresponding QoS requirement information and corresponding PCC rules are set for different access classes. When a 5QI is selected, a characteristic (including but not limited to indicators such as a bandwidth, a delay, a jitter characteristic, reliability, and a packet loss rate that are obtained through a QoS monitoring mechanism) of a current untrusted Wi-Fi access network may also be taken into account, so that QoS is more easily mapped between 5G and Wi-Fi.

In some exemplary embodiments, to simplify a protocol, the 5GC may also generate a unified set of QoS parameters that is configured for both NG-RAN access and the untrusted Wi-Fi access, and different characteristics of different untrusted Wi-Fi access are blocked through the N3IWF.

In some exemplary embodiments, new functions may be introduced to an SMF, but are not limited to the following: a function of performing optimization on the SMF with reference to the access characteristic of the untrusted Wi-Fi access when the SMF configures a QoS profile, a QoS rule, and an N4 rule (the N4 rule is QoS processing-related information transmitted to the UPF), so that QoS is more easily mapped between 5G and Wi-Fi.

In some exemplary embodiments, new functions are introduced to the N3IWF, but are not limited to the following:

1. A function of supporting a radio access side function in PDU set QoS processing, including but not limited to discarding a data packet in a PDU set when congestion occurs or useless and redundant data is detected.

In some embodiments, the function may be configured for performing congestion detection in an untrusted Wi-Fi network environment. For example, congestion is detected by collecting a backoff frequency of the UE.

In some embodiments, the function may be configured for identifying PSI or another field at an N2/N3 termination point such as the N3IWF, to select an appropriate data packet to perform a discarding operation when congestion occurs.

In some embodiments, specific parameters, such as a delay time requirement and a packet loss rate requirement, of operations, such as the PDU set QoS processing and data packet discarding that are performed in an untrusted Wi-Fi access condition, may be determined according to parameters such as a PSDB and a PSER that are provided by the 5GC.

2. A function of mapping downlink PDU set data to a Wi-Fi bearer, and mapping a 5G QoS parameter + PDU set QoS to a QoS mechanism of Wi-Fi.

In some embodiments, through the mechanism, a 5G QoS flow or a data flow with a finer granularity may be mapped to a TXOP of trusted Wi-Fi.

In some embodiments, the N3IWF may map PDU set data to a transmitting resource of the TXOP according to a resource characteristic of the TXOP.

3. In terms of delay monitoring, a function of considering a delay between the UE and the N3IWF, to correct a QoS delay requirement of the 5GS.

In some embodiments, if the 5GS starts QoS monitoring, delay measurement and reporting are performed between the UE and the N3IWF, and the N3IWF takes on a role of an N2/N3 termination point of the NG-RAN.

4. A function of performing congestion-based ECN marking for L4S.

In some embodiments, after the N3IWF detects congestion in the untrusted Wi-Fi access environment, the N3IWF may perform an operation of ECN marking for L4S.

In some exemplary embodiments, functions may be introduced to the UE, but are not limited to the following: a function of performing QoS optimization processing with reference to the access characteristic of the untrusted Wi-Fi access after the QoS rule configured by the SMF is obtained; and a function of completing QoS monitoring processing in coordination with the N3IWF, for example, completing measurement of a delay.

In conclusion, in the technical solutions in the embodiments of this application, a PDU set QoS processing mechanism defined in a 3GPP 5GS may be extended to a non-3GPP access scenario (for example, a W-Fi access scenario), so that the PDU set QoS mechanism implements interworking and integration of the 3GPP network and the non-3GPP network, which helps the service processing device that supports the 3GPP RAT and the non-3GPP access manner to perform switching according to the network environment and another factor (for example, a fee factor), thereby improving processing flexibility of the service data flow, and ensuring better popularization of an immersive multimedia service (for example, an XRM service).

The foregoing embodiments are described by using an example in which the service data is transmitted between the service processing device and the service server in the PDU set manner, and a processing manner for transmitting the service data between the service processing device and the service server in the per-packet manner is similar thereto, and details are not described again. In addition, the non-3GPP access manner refers to a radio access technology other than cellular network access technologies such as 3G, 4G, 5G, and 6G defined in the 3GPP, and the radio access technology includes, but is not limited to, a wireless local area network (WLAN) of an Institute of Electrical and Electronics Engineers (IEEE) 802.11 series, and a Wi-Fi technology defined by a corresponding Wi-Fi alliance.

The following describes an apparatus embodiment of this disclosure, and the apparatus embodiment may be used for performing the QoS processing method based on non-3GPP access in the foregoing embodiments of this application. For details not disclosed in the apparatus embodiment of this disclosure, refer to the QoS processing method based on non-3GPP access in the foregoing embodiments of this application.

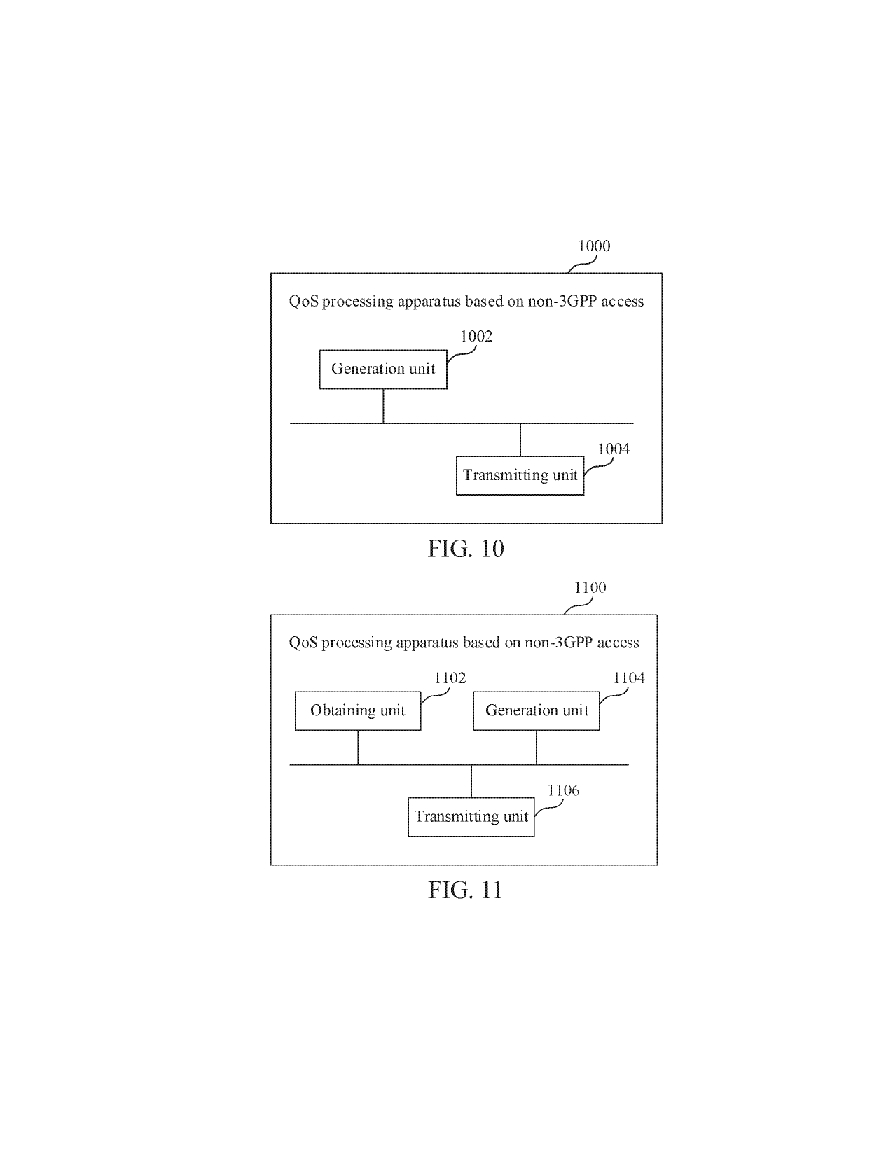

FIG. 9 is a block diagram of a QoS processing apparatus based on non-3GPP access according to an embodiment of this disclosure. The QoS processing apparatus may be applied to a target network element connected to a service processing device in a non-3GPP access manner, and the target network element is connected to a core network. For example, in a trusted non-3GPP access scenario, the QoS processing apparatus shown in FIG. 9 may be applied to a TNAN element. The network element may be one or more of TNAPs and TNGFs, or may be another network element. For another example, in an untrusted non-3GPP access scenario, the QoS processing apparatus shown in FIG. 3 may be applied to an N3IWF, or may be applied to another network element.

Referring to FIG. 9, a QoS processing apparatus 900 based on non-3GPP access according to an embodiment of this disclosure includes a receiving unit 902, and a processing unit 904.

The receiving unit 902 is configured to receive QoS profile information that is transmitted by a session management function network element and that corresponds to service data packet transmission performed between the service processing device and a service server. The processing unit 904 is configured to perform, according to the QoS profile information, QoS processing in a process of transmitting a service data packet between the service processing device and the service server.

In some embodiments of this application, based on the foregoing solutions, the processing unit 904 is configured to: discard a corresponding service data packet, if detecting, according to the QoS profile information, that at least one of the following conditions occurs in the process of transmitting the service data packet: congestion occurs in a process of transmitting a service data packet, transmission delay information of a service data packet is uncapable of satisfying a delay requirement, a bit error rate of a service data packet is uncapable of satisfying a bit error rate requirement, and a service data packet is determined as a useless and redundant data packet.

In some embodiments of this application, based on the foregoing solutions, the processing unit 904 is further configured to perform at least one of the following processes: detecting a process in which the service processing device transmits the service data packet in a non-3GPP access network environment, to determine whether congestion occurs in the process of transmitting the service data packet; and determining a priority of the service data packet according to field information included in the service data packet, to discard service data in ascending order of priorities when the service data needs to be discarded.

In some embodiments of this application, based on the foregoing solutions, the processing unit 904 is configured to: detect, according to a backoff frequency of the service processing device, the process in which the service processing device transmits the service data packet in the non-3GPP access network environment if the service processing device accesses the target network element in an EDCA manner, to determine whether congestion occurs in the process of transmitting the service data packet.

In some embodiments of this application, based on the foregoing solutions, the processing unit 904 is configured to: map a QoS parameter included in the QoS profile information to a QoS mechanism of the non-3GPP access manner, and map, according to the QoS mechanism of the non-3GPP access manner, a downlink service data packet transmitted by the service server to a bearer corresponding to the non-3GPP access manner, to transmit the downlink service data packet to the service processing device.

In some embodiments of this application, based on the foregoing solutions, the QoS profile information includes: a data flow QoS parameter; and the processing unit 904 is configured to: determine a data flow to which the downlink service data packet belongs; and map, according to the data flow QoS parameter in the QoS mechanism of the non-3GPP access manner, the data flow to which the downlink service data packet belongs to the bearer corresponding to the non-3GPP access manner, to transmit the downlink service data packet to the service processing device.

In some embodiments of this application, based on the foregoing solutions, the non-3GPP access manner includes a Wi-Fi access manner; and the processing unit 904 is configured to: map, according to the data flow QoS parameter in the QoS mechanism of the non-3GPP access manner, the data flow to which the downlink service data packet belongs to a TXOP corresponding to the Wi-Fi access manner or some transmission resources of a TXOP corresponding to the Wi-Fi access manner, to transmit the downlink service data packet to the service processing device.

In some embodiments of this application, based on the foregoing solutions, the QoS profile information includes: the data flow QoS parameter and a PDU set QoS parameter; and the processing unit 904 is configured to: determine the data flow and a PDU set to which the downlink service data packet belongs; and map, according to the data flow QoS parameter and the PDU set QoS parameter in the QoS mechanism of the non-3GPP access manner, the data flow and the PDU set to which the downlink service data packet belongs to the bearer corresponding to the non-3GPP access manner, to transmit the downlink service data packet to the service processing device.

In some embodiments of this application, based on the foregoing solutions, the non-3GPP access manner includes the Wi-Fi access manner; and the processing unit 904 is configured to: map, according to the data flow QoS parameter and the PDU set QoS parameter in the QoS mechanism of the non-3GPP access manner, the data flow and the PDU set to which the downlink service data packet belongs to the TXOP corresponding to the Wi-Fi access manner or some transmission resources of the TXOP corresponding to the Wi-Fi access manner, to transmit the downlink service data packet to the service processing device.

In some embodiments of this application, based on the foregoing solutions, the processing unit 904 is further configured to: obtain delay information between the target network element and the service processing device; and determine, with reference to the delay information when monitoring a transmission delay of the service data packet transmitted between the service processing device and the service server, whether the transmission delay of the service data packet satisfies a delay requirement included in the QoS profile information.

In some embodiments of this application, based on the foregoing solutions, the processing unit 904 is further configured to: obtain the delay information between the target network element and the service processing device; and transmit the delay information to a specified core network element, so that a policy control function network element generates, based on the delay information obtained from the specified core network element, QoS policy information that is configured for processing the service data packet, where the QoS profile information is obtained based on the QoS policy information.

In some embodiments of this application, based on the foregoing solutions, the processing unit 904 is further configured to: perform explicit congestion notification ECN marking on the service data packet if detecting that the service data packet transmitted between the service processing device and the service server experiences congestion.

In some embodiments of this application, based on the foregoing solutions, if the non-3GPP access manner is a trusted non-3GPP access manner, the target network element is a trusted non-3GPP access network element; and if the non-3GPP access manner is an untrusted non-3GPP access manner, the target network element is a non-3GPP interworking function network element.

In some embodiments of this application, based on the foregoing solutions, the service data packet transmitted between the service processing device and the service server is transmitted in a data packet set manner. The QoS parameter in the QoS profile information includes at least one of the following parameters: a protocol data unit PDU set delay budget, a PDU set error rate, a maximum data burst volume, and a data packet delay variation.

FIG. 10 is a block diagram of a QoS processing apparatus based on non-3GPP access according to an embodiment of this disclosure. The QoS processing apparatus may be applied to an AF, or may be applied to another network element.

Referring to FIG. 10, a QoS processing apparatus 1000 based on based on non-3GPP access according to an embodiment of this disclosure includes a generation unit 1002, and a transmitting unit 1004.

The generation unit 1002 is configured to generate QoS requirement information for a service data packet, and the service data packet is a data packet transmitted between a service server and a service processing device accessed in a non-3GPP access manner. The transmitting unit 1004 is configured to transmit the QoS requirement information to a policy control function network element, so that the policy control function network element generates, according to the QoS requirement information, QoS policy information corresponding to the service data packet.

In some embodiments of this application, based on the foregoing solutions, the generation unit 1002 is configured to: generate the QoS requirement information according to an access characteristic of the non-3GPP access manner; or

generate the same QoS requirement information for the non-3GPP access manner and a radio access network access manner.

FIG. 11 is a block diagram of a QoS processing apparatus based on non-3GPP access according to an embodiment of this disclosure. The QoS processing apparatus may be applied to a PCF, or may be applied to another network element.

Referring to FIG. 11, a QoS processing apparatus 1100 based on non-3GPP access according to an embodiment of this disclosure includes an obtaining unit 1102, a generation unit 1104, and a transmitting unit 1106.

The obtaining unit 1102 is configured to obtain QoS requirement information for a service data packet, and the service data packet is a data packet transmitted between a service server and a service processing device accessed in a non-3GPP access manner. The generation unit 1104 is configured to generate, according to the QoS requirement information, QoS policy information corresponding to the service data packet. The transmitting unit 1106 is configured to transmit the QoS policy information to a session management function network element, so that the session management function network element configures, according to the QoS policy information, QoS processing-related information for a processing device of the service data packet.

In some embodiments of this application, based on the foregoing solutions, the generation unit 1104 is configured to: generate, according to the QoS requirement information and an access characteristic of the non-3GPP access manner, the QoS policy information corresponding to the service data packet; or

generate, according to the QoS requirement information, the same QoS policy information for the non-3GPP access manner and a radio access network access manner.

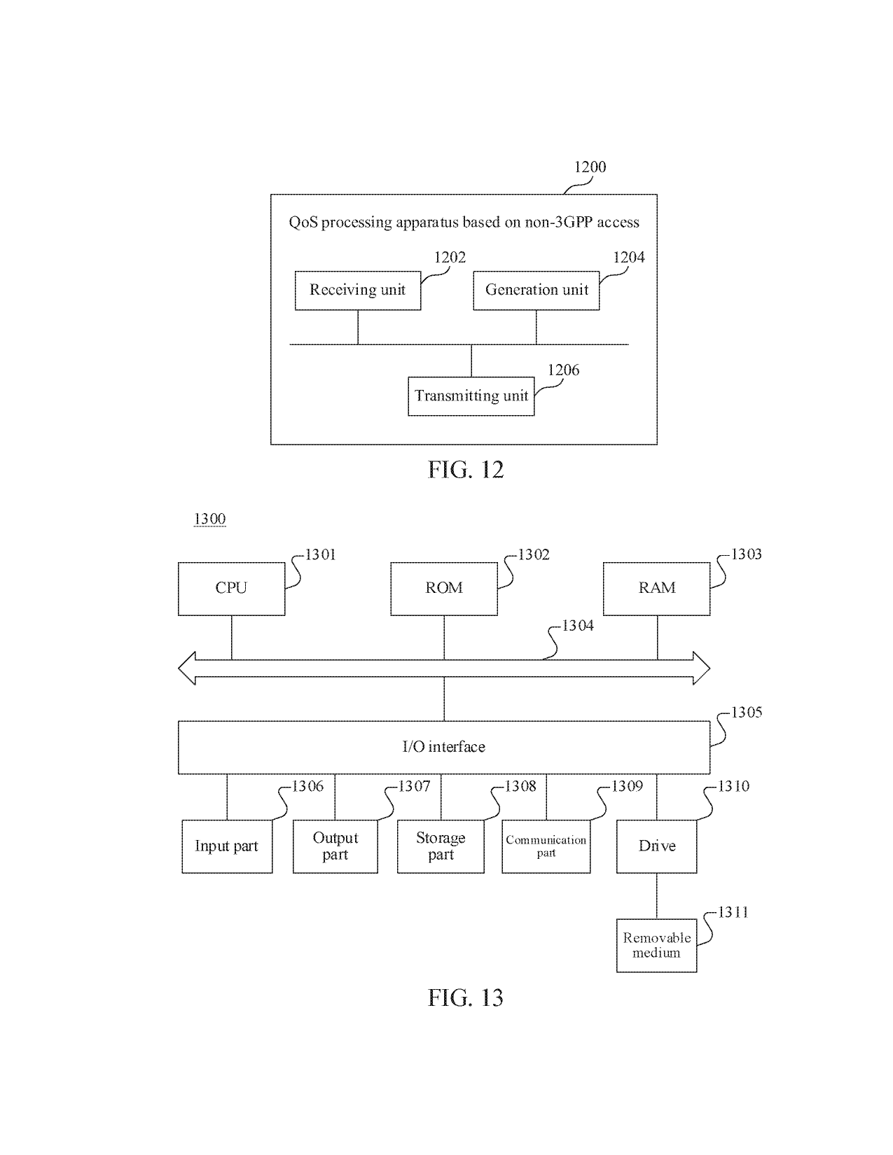

FIG. 12 is a block diagram of a QoS processing apparatus based on non-3GPP access according to an embodiment of this disclosure. The QoS processing apparatus may be applied to an SMF, or may be applied to another network element.

Referring to FIG. 12, a QoS processing apparatus 1200 based on non-3GPP access according to an embodiment of this disclosure includes a receiving unit 1202, a generation unit 1204, and a transmitting unit 1206.

The receiving unit 1202 is configured to receive QoS policy information that is transmitted by a policy control function network element and that is configured for processing a service data packet, and the service data packet is a data packet transmitted between a service server and a service processing device accessed in a non-3GPP access manner. The generation unit 1204 is configured to generate, according to the QoS policy information, QoS processing-related information respectively corresponding to various types of processing devices of the service data packet. The transmitting unit 1206 is configured to configure the QoS processing-related information for the processing devices of the service data packet.

In some embodiments of this application, based on the foregoing solutions, the generation unit 1204 is configured to: generate, according to the QoS policy information and an access characteristic of the non-3GPP access manner, the QoS processing-related information respectively corresponding to the various types of processing devices of the service data packet; or

generating, according to the QoS policy information, the same QoS processing-related information for the non-3GPP access manner and a radio access network access manner.

FIG. 13 is a schematic structural diagram of a computer system of an electronic device that is suitable for implementing embodiments of this application. The electronic device may be a target network element, an AF, a PCF or an SMF in the foregoing embodiments.

The computer system 1300 of the electronic device shown in FIG. 13 is merely an example, and is not to bring any limitation to a function and a use scope of the embodiments of this application.

As shown in FIG. 13, the computer system 1300 may include a central processing unit (CPU) 1301, which may perform various proper actions and processing according to a program stored in a read-only memory (ROM) 1302 or a program loaded from a storage part 1308 to a random access memory (RAM) 1303, for example, the computer system 1300 performs the methods described in the foregoing embodiments. The RAM 1303 further stores various programs and data required for a system operation. The CPU 1301, the ROM 1302, and the RAM 1303 are connected to each other through a bus 1304. An input/output (I/O) interface 1305 is also connected to the bus 1304.

The following components may be connected to the I/O interface 1305: an input part 1306 including a keyboard, a mouse, and the like; an output part 1307 including a cathode ray tube (CRT), a liquid crystal display (LCD), a speaker, and the like; a storage part 1308 including a hard disk, and the like; a communication part 1309 including a network interface card such as a local area network (LAN) card, a modem, and the like. The communication part 1309 performs communication processing through a network such as the internet. A drive 1310 is also connected to the I/O interface 1305 according to a requirement. A removable medium 1311, such as a magnetic disk, an optical disc, a magneto-optical disk, or a semiconductor memory, is installed on the drive 1310 according to a requirement, so that a computer program read from the removable medium 1311 is installed into the storage part 1308 according to a requirement.

Particularly, according to the embodiments of this application, the processes described above with reference to the flowcharts may be implemented as a computer software program. For example, an embodiment of this disclosure includes a computer program product, including a computer program carried in a computer readable medium, and the computer program is configured for performing the methods shown in the flowcharts. In such an embodiment, the computer program may be downloaded and installed from a network and/or installed from the removable medium 1311 through the communication part 1309. When the computer program is executed by the central processing unit (CPU) 1301, various functions defined in the system of this application are performed.

The computer-readable medium shown in the embodiments of this application may be a computer-readable signal medium or a computer-readable storage medium, or any combination thereof. The computer-readable storage medium may be, but is not limited to an electric, magnetic, optical, electromagnetic, infrared, or semiconductor system, apparatus, or device, or any combination thereof, and may include non-transitory storage medium. A more specific example of the computer-readable storage medium may include, but is not limited to: an electrical connection having one or more wires, a portable computer disk, a hard disk, a random access memory (RAM), a read-only memory (ROM), an erasable programmable read-only memory (EPROM), a flash memory, an optical fiber, a compact disc read-only memory (CD-ROM), an optical storage device, a magnetic storage device, or any suitable combination thereof. In this application, the computer-readable storage medium may be any tangible medium including or storing a computer program, and the computer program may be used by an instruction execution system, an apparatus, or a device, or be used in combination with the instruction execution system, the apparatus, or the device. However, in this application, a computer-readable signal medium may include a data signal propagated in a baseband or propagated as part of a carrier, where the data signal carries the computer-readable program. Such a propagated data signal may take a variety of forms, including but not limited to an electromagnetic signal, an optical signal, or any suitable combination thereof. The computer-readable signal medium may also be any computer-readable medium other than the computer-readable storage medium. The computer-readable medium may transmit, propagate, or transmit a program for use by or in combination with the instruction execution system, the apparatus, or the device. The computer program included in the computer-readable medium may be transmitted by using any suitable medium, including but not limited to a wireless medium, a wireline medium, or the like, or any suitable combination thereof.

Flowcharts and block diagrams in the accompanying drawings show architectures, functions, and operations that may be implemented by a system, a method, and the computer program product according to various embodiments of this application. Each block in the flowcharts or the block diagrams may represent a module, a program segment, or a part of code. The foregoing module, the foregoing program segment, or the part of code includes one or more executable instructions configured for implementing specified logic functions. In some implementations used as substitutes, functions marked in the blocks may also occur in a sequence different from that marked in the accompanying drawings. For example, two consecutive blocks may actually be executed substantially in parallel, and may sometimes be executed in a reverse order, depending on a function involved. Each block in the block diagrams or the flowcharts, and combinations of blocks in the block diagrams or flowcharts may be implemented by using a dedicated hardware-based system that performs a specified function or operation, or may be implemented by using a combination of dedicated hardware and the computer program.

Related units described in the embodiments of this application may be implemented in a software manner, or may be implemented in a hardware manner, or the described units may be disposed in a processor. Names of these units do not constitute limitations on these units in some cases.

In another aspect, this application further provides a computer-readable medium. The computer-readable medium may be included in the electronic device described in the foregoing embodiments; or the computer-readable medium may exist alone, and is not assembled into the electronic device. One or more computer programs are carried in the computer-readable medium, and when the foregoing one or more computer programs are executed by the electronic device, the electronic device is enabled to implement the methods described in the foregoing embodiments.

Although several modules or units of the device that are configured to perform an action are mentioned in the foregoing detailed descriptions, such division is not mandatory. In fact, according to implementations of this application, features and functions of two or more modules or units described above may be specific in one module or unit. On the contrary, a feature and function of one module or unit described above may be further divided into and be specific in a plurality of modules or units.

Based on the descriptions of the foregoing implementations, a person skilled in the art can easily understand that, exemplary implementations described herein may be implemented by software, or may be implemented by combining software with necessary hardware. Therefore, the technical solutions according to the implementations of this application may be implemented in a form of a software product. The software product may be stored in a non-volatile storage medium (which may be a CD-ROM, a USB flash drive, a removable hard disk, or the like) or on a network, and includes several instructions, so that the electronic device performs the methods according to the implementations of this application.

For example, the electronic device may be the target network element in the foregoing embodiments, and then the target network element may perform the QoS processing method based on non-3GPP access shown in FIG. 3. For another example, the electronic device may be the AF, and the AF may perform the QoS processing method based on non-3GPP access shown in FIG. 4. For still another example, the electronic device may be the PCF, and then the PCF may perform the QoS processing method based on non-3GPP access shown in FIG. 5. For another example, the electronic device may be the SMF, and the SMF may perform the QoS processing method based on non-3GPP access shown in FIG. 6.

A person skilled in the art can easily figure out another implementation solution of this application after considering this specification and practicing the implementations that are disclosed herein. This application is intended to cover any variations, functions, or adaptive changes of this application. These variations, functions, or adaptive changes comply with general principles of this application, and include common knowledge or a commonly used technical means in the technical field that is not disclosed in this application.

This application is not limited to the precise structures described above and shown in the accompanying drawings, and various modifications and changes can be made without departing from the scope of this application. The scope of this application is limited only by the appended claims.

What is claimed is:

1. A method for quality of service (QoS) processing based on non-3GPP access, the method being performed by a target network element connected to a service processing device in a non-3GPP access manner, the target network element being connected to a core network, and the QoS processing method comprising:
receiving, from a session management function (SMF) network element, QoS profile information corresponding to service data packet transmission performed between the service processing device and a service server; and
performing, based on the QoS profile information, QoS processing during transmission of a service data packet between the service processing device and the service server.

2. The method according to claim 1, wherein performing the QoS processing comprises:
discarding a corresponding service data packet, if detecting, based on the QoS profile information, that at least one of the following conditions occurs during transmission of the service data packet:
congestion occurs during transmission of the service data packet;
a transmission delay of the service data packet fails to satisfy a delay requirement specified in the QoS profile information;
a bit error rate of the service data packet fails to satisfy a bit error rate requirement specified in the QoS profile information; or
the service data packet is determined to be a useless and redundant data packet.

3. The method according to claim 2, further comprising at least one of following steps:
detecting the service processing device transmits a service data packet in a non-3GPP access network environment, to determine whether congestion occurs during transmission of the service data packet; or
determining a priority of the service data packet based on field information comprised in the service data packet, and discarding service data packets in ascending order of priorities when the service data packets are to be discarded.

4. The method according to claim 3, wherein detecting the service processing device transmits the service data packet in the non-3GPP access network environment, to determine whether congestion occurs during transmission of the service data packet comprises:
detecting, based on a backoff frequency of the service processing device, the process in which the service processing device transmits the service data packet in the non-3GPP access network environment, to determine whether congestion occurs during transmission of the service data packet if the service processing device accesses the target network element in an enhanced distributed channel access (EDCA) manner.

5. The method according to claim 1, wherein performing, based on the QoS profile information, QoS processing comprises:
mapping a QoS parameter comprised in the QoS profile information to a QoS mechanism of the non-3GPP access manner; and
mapping, based on the QoS mechanism of the non-3GPP access manner, a downlink service data packet transmitted by the service server to a bearer corresponding to the non-3GPP access manner, to transmit the downlink service data packet to the service processing device.

6. The method according to claim 5, wherein the QoS profile information comprises a data flow QoS parameter; and wherein mapping the downlink service data packet transmitted by the service server to the bearer corresponding to the non-3GPP access manner, to transmit the downlink service data packet to the service processing device comprises:
determining a data flow to which the downlink service data packet belongs; and
mapping, according to the data flow QoS parameter in the QoS mechanism of the non-3GPP access manner, the data flow to which the downlink service data packet belongs to the bearer corresponding to the non-3GPP access manner, to transmit the downlink service data packet to the service processing device.

7. The method according to claim 6, wherein the non-3GPP access manner comprises a wireless fidelity Wi-Fi access manner; and
mapping, according to the data flow QoS parameter in the QoS mechanism of the non-3GPP access manner, the data flow to which the downlink service data packet belongs to the bearer corresponding to the non-3GPP access manner, to transmit the downlink service data packet to the service processing device comprises:
mapping, according to the data flow QoS parameter in the QoS mechanism of the non-3GPP access manner, the data flow to which the downlink service data packet belongs to a transmission opportunity (TXOP) corresponding to the Wi-Fi access manner or a portion of transmission resources of a TXOP corresponding to the Wi-Fi access manner, to transmit the downlink service data packet to the service processing device.

8. The method according to claim 5, wherein the QoS profile information comprises: a data flow QoS parameter and a protocol data unit (PDU) set QoS parameter, and mapping the downlink service data packet transmitted by the service server to the bearer corresponding to the non-3GPP access manner comprises:
determining a data flow and a PDU set to which the downlink service data packet belongs; and
mapping, according to the data flow QoS parameter and the PDU set QoS parameter in the QoS mechanism of the non-3GPP access manner, the data flow and the PDU set to which the downlink service data packet belongs to the bearer corresponding to the non-3GPP access manner, to transmit the downlink service data packet to the service processing device.

9. The method according to claim 8, wherein the non-3GPP access manner comprises a Wi-Fi access manner; and wherein mapping, according to the data flow QoS parameter and the PDU set QoS parameter in the QoS mechanism of the non-3GPP access manner, the data flow and the PDU set to which the downlink service data packet belongs to the bearer corresponding to the non-3GPP access manner, to transmit the downlink service data packet to the service processing device comprises:
mapping, according to the data flow QoS parameter and the PDU set QoS parameter in the QoS mechanism of the non-3GPP access manner, the data flow and the PDU set to which the downlink service data packet belongs to a TXOP corresponding to the Wi-Fi access manner or a portion of transmission resources of a TXOP corresponding to the Wi-Fi access manner, to transmit the downlink service data packet to the service processing device.

10. The method according to claim 1, further comprising:
obtaining delay information indicative of a delay between the target network element and the service processing device; and
determining, with reference to the delay information when monitoring a transmission delay of the service data packet transmitted between the service processing device and the service server, whether the transmission delay of the service data packet satisfies a delay requirement comprised in the QoS profile information.

11. The method according to claim 1, further comprising:
obtaining the delay information indicative of the delay between the target network element and the service processing device; and
transmitting the delay information to a specified core network element, so that a policy control function (PCF) network element generates, based on the delay information obtained from the specified core network element, QoS policy information for processing the service data packet, wherein the QoS profile information is obtained based on the QoS policy information.

12. The method according to claim 1, further comprising:
performing explicit congestion notification (ECN) marking on the service data packet if detecting that the service data packet transmitted between the service processing device and the service server experiences congestion.

13. The method according to claim 1, wherein
if the non-3GPP access manner is a trusted non-3GPP access manner, the target network element is a trusted non-3GPP access network element; and
if the non-3GPP access manner is an untrusted non-3GPP access manner, the target network element is a non-3GPP interworking function network element.

14. The method according to claim 1, wherein the service data packet transmitted between the service processing device and the service server is transmitted in a data packet set manner; and
the QoS parameter in the QoS profile information comprises at least one of the following parameters: a PDU set delay budget, a PDU set error rate, a maximum data burst volume, and a data packet delay variation.

15. A device comprising a memory for storing computer instructions and a processor in communication with the memory, wherein, when the processor executes the computer instructions, the processor is configured to cause the device to:
receive, from a session management function (SMF) network element, Quality of Service (QoS) profile information corresponding to service data packet transmission performed between the service processing device and a service server; and
perform, based on the QoS profile information, QoS processing during transmission of a service data packet between the service processing device and the service server.

16. The device according to claim 15, wherein, when the processor is configured to cause the device to perform the QoS processing, the processor is configured to cause the device to:
discard a corresponding service data packet, if detecting, based on the QoS profile information, that at least one of the following conditions occurs during transmission of the service data packet:
congestion occurs during transmission of the service data packet;
a transmission delay of the service data packet fails to satisfy a delay requirement specified in the QoS profile information;
a bit error rate of the service data packet fails to satisfy a bit error rate requirement specified in the QoS profile information; or
the service data packet is determined to be a useless and redundant data packet.

17. The device according to claim 16, the processor is configured to further cause the device to perform at least one of following:
detecting the service processing device transmits a service data packet in a non-3GPP access network environment, to determine whether congestion occurs during transmission of the service data packet; or
determining a priority of the service data packet based on field information comprised in the service data packet, and discarding service data packets in ascending order of priorities when the service data packets are to be discarded.

18. A non-transitory storage medium for storing computer readable instructions, the computer readable instructions, when executed by a processor, causing the processor to:
receive, from a session management function (SMF) network element, Quality of Service (QoS) profile information corresponding to service data packet transmission performed between the service processing device and a service server; and
perform, based on the QoS profile information, QoS processing during transmission of a service data packet between the service processing device and the service server.

19. The non-transitory storage medium according to claim 18, wherein, when the computer readable instructions cause the processor to perform the QoS processing, the computer readable instructions cause the processor to:
discard a corresponding service data packet, if detecting, based on the QoS profile information, that at least one of the following conditions occurs during transmission of the service data packet:
congestion occurs during transmission of the service data packet;
a transmission delay of the service data packet fails to satisfy a delay requirement specified in the QoS profile information;
a bit error rate of the service data packet fails to satisfy a bit error rate requirement specified in the QoS profile information; or
the service data packet is determined to be a useless and redundant data packet.

20. The non-transitory storage medium according to claim 19, the computer readable instructions further cause the processor to perform at least one of following:
detecting the service processing device transmits a service data packet in a non-3GPP access network environment, to determine whether congestion occurs during transmission of the service data packet; or
determining a priority of the service data packet based on field information comprised in the service data packet, and discarding service data packets in ascending order of priorities when the service data packets are to be discarded.
